(19) United States
(12) Patent Application Publication
(10) Pub. No.: US 2026/0047567 A1
(43) Pub. Date: Feb. 19, 2026

(54) DURABLE SOLID PEST BARRIERS DEPLOYABLE ABOUT STRUCTURES AND METHODS OF MAKING AND USING THE SAME

(71) Applicant: DANIEL CHECK, CONWAY, SC (US)

(72) Inventor: DANIEL CHECK, CONWAY, SC (US)

(21) Appl. No.: 18/821,699

(22) Filed: Aug. 30, 2024

Related U.S. Application Data
(60) Provisional application No. 63/683,515, filed on Aug. 15, 2024.

(51) Int. Cl. A01M 1/24; A01M 1/20

(52) U.S. Cl. CPC A01M 1/245; A01M 1/2055

(57) ABSTRACT

Described are systems, devices, compositions of matter, and methods associated with solid pest barriers. The solid pest barrier can comprise one or more pest control chemical(s), such as an insecticide, a pesticide, an herbicide, and/or the like. Solid pest barrier can be configured to degrade or weather over time, thereby releasing pest control chemical(s). Solid pest barrier can further comprise a curable or cross-linkable material mixed with pest control chemical(s). This mixture can be extruded to form the solid pest barrier. Alternatively, solid pest barrier can comprise an inner chamber or pores that are configured to releasably retain the pest control chemical(s). Solid pest barrier can comprise flexible materials that are woven together, with pores being formed within the flexible materials and also between the flexible materials once woven together to form the solid pest barrier. Such pores can be dimensioned and configured to releasably retain therein/therebetween pest control chemical(s).

### CROSS-REFERENCE TO RELATED APPLICATIONS

The present application claims the benefit of priority under 35 U.S.C. §§119(e) and 120, in accordance with 37 C.F.R. §1.78(a), to U.S. Provisional Patent Application Ser. No. 63/683,515, filed Aug. 15, 2024 and entitled “Solid Pest Barriers and Methods of Making and Using the Same,” the entire disclosure of which is hereby incorporated herein by reference in its entirety for all purposes.

### FIELD

The present application relates to solid pest barrier systems and devices, methods of making the same, and methods of using the same.

### BACKGROUND

Pest management is typically carried out by applying a chemical management chemical (e.g., pesticides) to an application area in an aerosolized form, in a liquid form, or in pellet form. In aerosol form, pest management chemicals typically must be applied by a professional that is using respiratory protection, such as a high-efficiency particulate air (HEPA) filtration mask, a self-contained breathing apparatus (SCBA), or the like. The cost and material waste associated with this form of pest management chemical application is often relatively large. This can be from, among other things, the relatively low percentage of aerosol form pest management chemicals emitted that actually reach the desired destination within the application area. Further, the risk of acute and chronic toxicological effects to professionals applying such aerosol form pest management chemicals can be relatively high. This can be from, among other things, the concentration of aerosol form pest management chemical application events to a relatively small number of pest management professionals. When applied by a layperson, the risk of toxicological effects from aerosol form pest management chemical application can be much higher because a layperson often does not have and/or use the correct personal protective equipment (PPE) required to reduce such toxicological effects.

In liquid form, pest management chemicals typically include active ingredients dissolved in a carrier liquid, such as water, so that the active ingredient can be applied more evenly over an application area while achieving an appropriate short-term application dosage and without risking acute or chronic toxicological effects for a user due to dermal or other exposures to the pest management chemicals during application. However, because of the dilute nature of liquid-based application of pest management chemicals and the short-term effectiveness thereof, these products are typically inefficient in terms of manufacturing and shipping the carrier liquid around in order to deliver a relatively small amount of active ingredients to the application area. Also, in liquid form, the fate and transport of applied pest management chemicals typically results in some amount of non-point source pollution, such as in rainwater runoff to surface waterways or by percolation into soil and groundwater. Since liquid form pest management chemical application is often carried out by a homeowner or other non-pest management professional, the total human toxicological exposure to the active ingredients is spread across more people and the average person applying these ingredients is often less than that associated with aerosol form pest management chemical application. However, as noted, the manufacturing, storage, transportation, and use of liquid form pest management chemicals is typically inefficient due at least to the inactive carrier liquid predominating the products and the fate and transport of applied chemicals to areas outside of the application area, among other downsides.

In pellet form, the pellets are often deployed by direct ground application in a dispersed manner. However, dispersion or distribution of pellets necessarily requires that a non-zero distance is maintained between each discrete pellet and adjacent pellet(s) in order to achieve the desired dispersion or distribution over an application area. By forming a non-zero distance between discrete pellets of the pest management chemical, pests can simply navigate between the discrete pellets to freely maneuver through the application area, such as into a structure about which the pest management chemical pellets are distributed.

Further, the pest management chemicals, whether in aerosol, form, liquid form, or pellet form are also typically only effective for a short period of time after application thereof within the application area. This means that, typically, many, more frequent, applications of the pest management chemicals are required to achieve a mid-term or long-term effective pest management strategy.

Also, during an application period during which conventional pest management chemicals are active within the application area, a user is not able to determine when the application period has ended. For example, a conventional liquid pest management chemical may be predicted to have an average effective period of pesticidal effectiveness of about 30-90 days, where the actual period of pesticidal effectiveness of the conventional liquid pest management chemical for any particular application area will depend on a variety of factors such as method of application, local wind speed and direction, local relative humidity and temperature, local precipitation types and amounts, and the like. However, there is typically no effective approach for determining if or when a conventional liquid pest management chemical has migrated out of the application area or otherwise become substantially ineffective for deterring or eradicating pest(s). Users of aerosol-form conventional pest management chemicals typically experience the same or similar problems as those discussed above regarding conventional liquid-form pest management chemicals.

Additionally, after application, deployment, or distribution of conventional pest management chemicals, whether in aerosol form, liquid form, or pellet form, cannot effectively ne removed from the application area, such as during or after an application period during which the pest management chemicals are active.

The inventor in this present application has conceived of, and constructively reduced to practice, several solutions to the above-described problems associated with liquid form pest management chemicals and aerosol form pest management chemicals.

### SUMMARY

Described are systems, devices, compositions of matter, and methods associated with solid pest barriers. According to some embodiments, a system can be provided that comprises a solid pest barrier. According to another embodiment, a solid pest barrier can be provided that can comprise or take the form of a cord, a ribbon, a sleeve, a landscaping edging barrier, a wall, a channel, a board, a chain, a comb, a spike, a tower, a band, a rope wick, a wiper, other suitable form factors, and/or the like, the solid pest barrier being configured to comprise or releasably retain one or more pest control chemical(s). According to other embodiments, a method of forming a solid pest barrier can be carried out. According to other embodiments, a method of deploying a solid pest barrier can be carried out. According to other embodiments, a method of providing a replenishing supply of the pest control chemical(s).

According to some embodiments, a method for forming a solid pest barrier can be carried out that comprises providing a curable fluid matrix material; disposing a pest control chemical disposed within the curable fluid matrix material; and extruding a mixture of the pest control chemical and the curable fluid matrix material to form a solid pest barrier having a substantially cord-like form factor.

In other embodiments, a solid pest barrier can be formed/manufactured by providing a curable fluid matrix material; disposing a pest control chemical disposed within the curable fluid matrix material; extruding a mixture of the pest control chemical and the curable fluid matrix material to form a solid pest barrier having a substantially cord-like form factor; and disposing an adhesive material onto at least a portion of the solid pest barrier to make the solid pest barrier adherable to an outer surface of a structure. In some embodiments, the adhesive material disposed between the solid pest barrier and the outer surface of the structure enables the solid pest barrier to be coupled to the structure and be continuously supported on the structure without forming any gaps between the solid pest barrier and the structure.

In other embodiments, a solid pest barrier can be formed by forming a porous flexible material having a substantially columnar form factor, the porous flexible material defining therein a plurality of microchannels; and disposing one or more pest control chemicals within the plurality of microchannels to form a solid pest barrier.

In other embodiments, a solid pest barrier can be formed by forming a substantially cord-like or rope-like material defining therein a plurality of microchannels having an average largest diameter within a predetermined range; and disposing one or more pest control chemicals within the plurality of microchannels defined within the substantially cord-like or rope-like material to form a solid pest barrier.

According to other embodiments, a solid pest barrier can be formed by comprise mixing one or more pest control chemicals into a biodegradable material to form an extrudable mixture; and extruding the extrudable mixture to form a solid pest barrier having a substantially cord-like or rope-like form factor.

Alternatively, a solid pest barrier can be formed by forming a plurality of flexible material elements, the plurality of flexible material elements having a substantially rope strand-like form factor, wherein respective of the plurality of flexible material elements comprise a first plurality of pores defined therein; disposing one or more pest control chemicals into the first plurality of pores of respective of the plurality of flexible material elements, the one or more pest control chemicals being configured to repel or cause mortality for one or more undesirable pests upon contact or ingestion by the one or more undesirable pests of the one or more pest control chemicals, the first plurality of pores being dimensioned and configured to releasably retain the one or more pest control chemicals therein; and weaving the plurality of flexible material elements together to form a solid pest barrier, the solid pest barrier having a substantially cord-like or rope-like form factor, the solid pest barrier defining a second plurality of pores between the plurality of flexible material elements once woven together, the second plurality of pores between the plurality of flexible material elements within the solid pest barrier being substantially empty.

Alternatively, a solid pest barrier can be formed by forming a plurality of flexible material elements, the plurality of flexible material elements having a substantially rope strand-like form factor, wherein respective of the plurality of flexible material elements comprise a first plurality of pores defined therein; disposing one or more pest control chemicals into the first plurality of pores of respective of the plurality of flexible material elements, the one or more pest control chemicals being configured to repel or cause mortality for one or more undesirable pests upon contact or ingestion by the one or more undesirable pests of the one or more pest control chemicals, the first plurality of pores being dimensioned and configured to releasably retain the one or more pest control chemicals therein; weaving the plurality of flexible material elements together to form a solid pest barrier, the solid pest barrier having a substantially cord-like or rope-like form factor, the solid pest barrier defining a second plurality of pores between the plurality of flexible material elements once woven together, the second plurality of pores between the plurality of flexible material elements within the solid pest barrier being substantially empty; and causing an aqueous liquid to be absorbed into some or all of the second plurality of pores between the plurality of flexible material elements within the solid pest barrier, causing the solid pest barrier to release at least a portion of the one or more pest control chemicals releasably retained within the first plurality of pores within respective of the plurality of flexible material elements, thereby facilitating exposure of the one or more pest control chemicals to the one or more undesirable pests.

According to some embodiments, a method for deploying a solid pest barrier can be provided. The method can comprise disposing an adhesive material onto at least a portion of a solid pest barrier to make the solid pest barrier adherable to an outer surface of a structure; and disposing the solid pest barrier onto the outer surface of the structure with the adhesive material disposed therebetween. Optionally, the method can further comprise forming the solid pest barrier by providing a curable fluid matrix material; disposing a pest control chemical disposed within the curable fluid matrix material; and extruding a mixture of the pest control chemical and the curable fluid matrix material to form the solid pest barrier having a substantially cord-like form factor.

In some embodiments, the solid pest barrier can be longitudinally and/or transversally continuous, e.g., physically and/or from the perspective of pesticidal effectiveness. Said otherwise, the solid pest barrier may be continuous lengthwise along a length of the solid pest barrier and may also be continuous crosswise across a cross-sectional diameter or width of the solid pest barrier. This may reduce or prevent the formation of gaps longitudinally along a length of the solid pest barrier and allow for better abutment of the solid pest barrier against the ground or an outer surface of a structure, for example. Conversely, conventional pest management chemicals in liquid form or pellet form necessarily creates or maintains gaps along a length of deployment or dispersion, e.g., about a structure.

In some embodiments, the solid pest barrier can be configured to directly abut an outer surface of a structure, such that the pesticidal coverage is continuous in a transverse (cross-directional) direction across the solid pest barrier.

Some or all of the elements of these methods for forming/manufacturing and/or deploying a solid pest barrier can be carried out by or controlled by a computing device, such as a computing device comprising a processing element that can, based upon instructions/program code stored in a volatile memory and/or a non-volatile memory of the computing device, cause and control operation of another component or element of a system/device to perform the steps/elements.

In some embodiments, a solid pest barrier can comprise an inner volume that is configured to releasably receive pest control chemical(s), such as an insecticide, a pesticide, an herbicide, and/or the like. The solid pest barrier can comprise a single inner chamber configured to releasably retain a supply of the pest control chemical(s). Alternatively, the solid pest barrier can comprise a plurality of apertures, pores, capillaries, cavities, channels, or the like that are configured to releasably retain a supply of the pest control chemical(s).

According to an embodiment, a system can be provided that comprises a solid pest barrier disposed about a structure, such as a dwelling or commercial building.

According to another embodiment, a solid pest barrier can be provided that comprises a flexible woven material having a substantially cord-like or rope-like form factor. In some embodiments, the flexible woven material comprises a plurality of flexible material elements that are woven together, the plurality of flexible material elements having a substantially rope strand-like form factor. In some embodiments, a respective flexible material element of the plurality of flexible material elements comprises a first plurality of pores within the flexible material element. In some embodiments, the flexible woven material defines a second plurality of pores between the plurality of flexible material elements woven together to form the flexible woven material. In some embodiments, the first plurality of pores within respective of the plurality of flexible material elements are dimensioned and configured to releasably retain one or more pest control chemicals within the first plurality of pores. In some embodiments, the one or more pest control chemicals are configured to repel or cause mortality for one or more undesirable pests upon contact or ingestion by the one or more undesirable pests of the one or more pest control chemicals. In some embodiments, the second plurality of pores between the plurality of flexible material elements within the flexible woven material are substantially empty prior to deployment of the solid pest barrier. In some embodiments, in an instance in which an aqueous liquid is absorbed into some or all of the second plurality of pores between the plurality of flexible material elements within the flexible woven material, at least a portion of the one or more pest control chemicals releasably retained within the first plurality of pores within respective of the plurality of flexible material elements are released from the solid pest barrier, thereby facilitating exposure of the one or more pest control chemicals to the one or more undesirable pests.

In some embodiments, the flexible woven material has a first coefficient of moisture expansion within a first predetermined range, and wherein respective of the flexible material elements have a second coefficient of moisture expansion within a second predetermined range. In some embodiments, the second plurality of pores defined within respective of the plurality of flexible material elements are dimensioned and configured to releasably retain the one or more pest control chemicals within the second plurality of pores using capillary action.

According to another embodiment, a solid pest barrier can be provided that comprises a porous flexible material having a substantially columnar form factor, the porous flexible material defining therein a plurality of microchannels; and one or more pest control chemicals disposed within the plurality of microchannels. In some embodiments, the porous flexible material has a coefficient of moisture expansion within a predetermined range such that the plurality of microchannels have a first average diameter within a first average diameter range when the porous flexible material is in a substantially dry configuration. In some embodiments, the plurality of microchannels have a second average diameter within a second average diameter range when the porous flexible material is in a wetted configuration. In some embodiments, the second average diameter range is larger than the first average diameter range. In some embodiments, when the porous flexible material is in the substantially dry configuration and has the first average diameter, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, when the porous flexible material is in the wetted configuration and the plurality of microchannels have the second average diameter, the plurality of microchannels are dimensioned and configured to release some or all of the one or more pest control chemicals previously retained within the plurality of microchannels. In some embodiments, this may cause release of at least a portion of the one or more pest control chemicals from the solid pest barrier, thereby facilitating exposure of the one or more pest control chemicals to the one or more undesirable pests.

According to another embodiment, a solid pest barrier can be provided that comprises a porous flexible material having a substantially columnar form factor. In some embodiments, the porous flexible material defines therein a plurality of microchannels having an average largest diameter within a predetermined range. In some embodiments, the solid pest barrier can further comprise one or more pest control chemicals disposed within the plurality of microchannels defined within the porous flexible material. In some embodiments, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, the porous flexible material is configured to become increasingly friable during a desired pest control period following deployment of the solid pest barrier within an application area. In some embodiments, during the desired pest control duration following deployment of the solid pest barrier within the application area, as the porous flexible material becomes increasingly friable, the plurality of microchannels are dimensioned and configured to release some or all of the one or more pest control chemicals previously retained within the plurality of microchannels. This may cause release of at least a portion of the one or more pest control chemicals from the solid pest barrier, thereby facilitating exposure of the one or more pest control chemicals to the one or more undesirable pests.

In some embodiments, the porous flexible material is configured to become increasingly friable in response to exposure to one or more environmental elements. In some embodiments, the one or more environmental elements comprise at least one of: sunlight, irrigation water, rain, humidity, wind, heat, cold, or combinations thereof.

According to another embodiment, a solid pest barrier can be provided that comprises a biodegradable material having a substantially cord-like or rope-like form factor; and one or more pest control chemicals disposed within the biodegradable material. In some embodiments, the one or more pest control chemicals are configured to repel or cause mortality for one or more undesirable pests upon contact or ingestion by the one or more undesirable pests of the one or more pest control chemicals. In some embodiments, the biodegradable material is configured to biodegrade during a desired pest control period following deployment of the solid pest barrier within an application area. In some embodiments, during the desired pest control duration following deployment of the solid pest barrier within the application area, as the biodegradable material biodegrades, some or all of the one or more pest control chemicals disposed within the biodegradable material is released from the solid pest barrier, thereby facilitating exposure of the one or more pest control chemicals to the one or more undesirable pests.

In some embodiments, the biodegradable material is configured to at biodegrade in response to exposure to one or more environmental elements. In some embodiments, the one or more environmental elements comprise at least one of: sunlight, irrigation water, rain, humidity, wind, heat, cold, or combinations thereof. In some embodiments, the biodegradable material is configured to biodegrade at a rate that is sufficient such that the biodegradable material fully biodegrades at an end of the desired pest control duration following deployment of the solid pest barrier within the application area. In some embodiments, the decomposable material comprises polyglycolic acid, polylactic acid, polycaprolactone (PCL), and poly(lactide-co-glycolide) (PLGA), or combinations thereof.

According to another embodiment, a method can be carried out that comprises forming a plurality of flexible material elements, the plurality of flexible material elements having a substantially rope strand-like form factor, wherein respective of the plurality of flexible material elements comprise a first plurality of pores defined therein. The method can further comprise disposing one or more pest control chemicals into the first plurality of pores of respective of the plurality of flexible material elements. In some embodiments, the one or more pest control chemicals are configured to repel or cause mortality for one or more undesirable pests upon contact or ingestion by the one or more undesirable pests of the one or more pest control chemicals. In some embodiments, the first plurality of pores are dimensioned and configured to releasably retain the one or more pest control chemicals therein. In some embodiments, the method can further comprise weaving the plurality of flexible material elements together to form a solid pest barrier. In some embodiments, the solid pest barrier has a substantially cord-like or rope-like form factor. In some embodiments, the solid pest barrier defines a second plurality of pores between the plurality of flexible material elements once woven together. In some embodiments, the second plurality of pores between the plurality of flexible material elements within the solid pest barrier are substantially empty. In some embodiments, in an instance in which an aqueous liquid is absorbed into some or all of the second plurality of pores between the plurality of flexible material elements within the solid pest barrier, the solid pest barrier is configured to release at least a portion of the one or more pest control chemicals releasably retained within the first plurality of pores within respective of the plurality of flexible material elements, thereby facilitating exposure of the one or more pest control chemicals to the one or more undesirable pests.

In some embodiments, the solid pest barrier has a first coefficient of moisture expansion within a first predetermined range, and wherein respective of the flexible material elements have a second coefficient of moisture expansion within a second predetermined range. In some embodiments, the second plurality of pores defined within respective of the plurality of flexible material elements are dimensioned and configured to releasably retain the one or more pest control chemicals within the second plurality of pores using capillary action.

According to another embodiment, a method can be carried out that comprises forming a porous flexible material having a substantially columnar form factor, the porous flexible material defining therein a plurality of microchannels; and disposing one or more pest control chemicals within the plurality of microchannels to form a solid pest barrier. In some embodiments, the porous flexible material has a coefficient of moisture expansion within a predetermined range such that the plurality of microchannels have a first average diameter within a first average diameter range when the porous flexible material is in a substantially dry configuration. In some embodiments, the plurality of microchannels have a second average diameter within a second average diameter range when the porous flexible material is in a wetted configuration, the second average diameter range being larger than the first average diameter range. In some embodiments, when the porous flexible material is in the substantially dry configuration and have the first average diameter, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, when the porous flexible material is in the wetted configuration and the plurality of microchannels have the second average diameter, the plurality of microchannels are dimensioned and configured to release some or all of the one or more pest control chemicals previously retained within the plurality of microchannels, causing release of at least a portion of the one or more pest control chemicals from the solid pest barrier, thereby facilitating exposure of the one or more pest control chemicals to the one or more undesirable pests.

According to another embodiment, a method can be carried out that comprises forming a substantially cord-like or rope-like material defining therein a plurality of microchannels having an average largest diameter within a predetermined range; and disposing one or more pest control chemicals within the plurality of microchannels defined within the substantially cord-like or rope-like material to form a solid pest barrier. In some embodiments, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, the substantially cord-like or rope-like material is configured to become increasingly friable during a desired pest control period following deployment of the solid pest barrier within an application area. In some embodiments, during the desired pest control duration following deployment of the solid pest barrier within the application area, as the substantially cord-like or rope-like material becomes increasingly friable, the plurality of microchannels are dimensioned and configured to release some or all of the one or more pest control chemicals previously retained within the plurality of microchannels, causing release of at least a portion of the one or more pest control chemicals from the solid pest barrier, thereby facilitating exposure of the one or more pest control chemicals to the one or more undesirable pests.

In some embodiments, the porous flexible material is configured to become increasingly friable in response to exposure to one or more environmental elements. In some embodiments, the one or more environmental elements comprise at least one of: sunlight, irrigation water, rain, humidity, wind, heat, cold, or combinations thereof.

According to another embodiment, a method can be carried out that comprises mixing one or more pest control chemicals into a biodegradable material to form an extrudable mixture; and extruding the extrudable mixture to form a solid pest barrier having a substantially cord-like or rope-like form factor. In some embodiments, the one or more pest control chemicals are configured to repel or cause mortality for one or more undesirable pests upon contact or ingestion by the one or more undesirable pests of the one or more pest control chemicals. In some embodiments, the biodegradable material is configured to biodegrade during a desired pest control period following deployment of the solid pest barrier within an application area. In some embodiments, during the desired pest control duration following deployment of the solid pest barrier within the application area, as the biodegradable material biodegrades, some or all of the one or more pest control chemicals disposed within the biodegradable material is released from the solid pest barrier, thereby facilitating exposure of the one or more pest control chemicals to the one or more undesirable pests.

In some embodiments, the biodegradable material is configured to at biodegrade in response to exposure to one or more environmental elements. In some embodiments, the one or more environmental elements comprise at least one of: sunlight, irrigation water, rain, humidity, wind, heat, cold, or combinations thereof. In some embodiments, the biodegradable material is configured to biodegrade at a rate that is sufficient such that the biodegradable material fully biodegrades at an end of the desired pest control duration following deployment of the solid pest barrier within the application area. In some embodiments, the decomposable material comprises polyglycolic acid, polylactic acid, polycaprolactone (PCL), and poly(lactide-co-glycolide) (PLGA), or combinations thereof.

According to another embodiment, a system can be provided that comprises a pest control barrier comprising a solid pest barrier material comprising one or more inner volumes defined therein and one or more portions of a pest control chemical disposed within the one or more inner volumes of the solid pest barrier material. In some embodiments, the pest control chemical is configured to repel or cause mortality for an undesired pest upon contact or ingestion of the pest control chemical by the undesirable pest. In some embodiments, the pest control barrier material is dimensioned and configured to releasably retain the one or more portions of the pest control chemical within the one or more inner volumes of the pest control barrier using capillary forces. In some embodiments, the system further comprises a pest control chemical reservoir configured to be in fluidic communication with the pest control barrier. In some embodiments, the pest control chemical reservoir is dimensioned and configured to retain a replenishing supply of the pest control chemical within the pest control chemical reservoir.

### BRIEF DESCRIPTION OF THE DRAWINGS

Having thus described the invention in general terms, reference will now be made to the accompanying drawings. The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIGS. 1A-1B illustrate a solid pest barrier system, according to embodiments of the present disclosure. FIG. 1A illustrates a solid pest barrier system in which a solid pest barrier is disposed about a building or structure at a non-zero distance from the building or structure. FIG. 1B illustrates a solid pest barrier system in which a solid pest barrier is disposed on some or all of one or more exterior surfaces of the building or structure.

FIGS. 2A-2B illustrate an example of a solid pest barrier, according to embodiments of the present disclosure. FIG. 2A illustrates a solid pest barrier that is substantially nonporous, while FIG. 2B illustrates a solid pest barrier that is at least partially porous.

FIG. 3 illustrates an example of a solid pest barrier, according to some embodiments of the present disclosure.

FIGS. 4A-4C illustrate examples of a solid pest barrier, according to some embodiments of the present disclosure. FIG. 4A illustrates a solid pest barrier comprising a plurality of microchannels defined in at least a portion of the solid pest barrier. FIG. 4B illustrates a cutout of a portion of the solid pest barrier illustrated in FIG. 4A, with the plurality of microchannels being impregnated with pest control chemical(s). FIG. 4C illustrates another embodiment of a solid pest barrier in which the plurality of microchannels are defined within the solid pest barrier on additional portions/sides of the solid pest barrier.

FIGS. 5A-5C illustrate an example of a solid pest barrier, according to embodiments of the present disclosure. FIG. 5A is a perspective view of the solid pest barrier; FIG. 5B is a longitudinal view of the solid pest barrier; and FIG. 5C is a cutaway side-view of the solid pest barrier.

FIG. 6 illustrates an example of a solid pest barrier, according to embodiments of the present disclosure.

FIG. 7 illustrates an example of a solid pest barrier partially impregnated with pest control chemical(s), according to embodiments of the present disclosure.

FIG. 8 illustrates an example of a solid pest barrier partially impregnated with pest control chemical(s), according to embodiments of the present disclosure.

FIG. 9 illustrates an example approach for deploying a solid pest barrier, according to embodiments of the present disclosure.

FIGS. 10A-10B illustrate an example approach for deploying a solid pest barrier at least partially about a structure, according to embodiments of the present disclosure. FIG. 10A illustrates the deployment of the solid pest barrier; while FIG. 10B illustrates the partial degradation of the solid pest barrier during a pest control period following deployment of the solid pest barrier.

FIG. 11 illustrates an example approach for impregnating a solid pest barrier material with pest control chemical(s), according to embodiments of the present disclosure.

FIG. 12 illustrates a schematic of an example computing device according to any of the approaches or methods of the present disclosure.

FIG. 13 is a block flow diagram of a method for forming a solid pest barrier, in accordance with embodiments of the present disclosure.

FIG. 14 is a block flow diagram of a method for forming a solid pest barrier, in accordance with embodiments of the present disclosure.

FIG. 15 is a block flow diagram of a method for forming a solid pest barrier, in accordance with embodiments of the present disclosure.

FIG. 16 is a block flow diagram of a method for forming a solid pest barrier, in accordance with embodiments of the present disclosure.

FIG. 17 is a block flow diagram of a method for forming a solid pest barrier, in accordance with embodiments of the present disclosure.

FIG. 18 is a block flow diagram of a method for forming a solid pest barrier, in accordance with embodiments of the present disclosure.

FIG. 19 is a block flow diagram of a method for using a solid pest barrier, in accordance with embodiments of the present disclosure.

FIG. 20 is a block flow diagram of a method for using a solid pest barrier, in accordance with embodiments of the present disclosure.

FIG. 21 is a block flow diagram of a method for using a solid pest barrier, in accordance with embodiments of the present disclosure.

FIG. 22 is a block flow diagram of a method for using a solid pest barrier, in accordance with embodiments of the present disclosure.

FIG. 23 is a block flow diagram of a method for using a solid pest barrier, in accordance with embodiments of the present disclosure.

FIG. 24 is a block flow diagram of a method for using a solid pest barrier, in accordance with embodiments of the present disclosure.

FIG. 25 is a block flow diagram of a method for using a solid pest barrier, in accordance with embodiments of the present disclosure.

FIG. 26 is a block flow diagram of a method for using a solid pest barrier, in accordance with embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Before the present materials, articles and/or methods are disclosed and described, it is to be understood that the aspects described below are not limited to specific compounds, synthetic methods, or uses, as such may, of course, vary. It is also to be understood that the terminology used herein is for the purpose of describing particular aspects only and is not intended to be limiting.

In the specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “a solvent” includes mixtures of two or more solvents and the like.

“Optional” or “optionally” means that the subsequently described event or circumstance can or cannot occur, and that the description includes instances where the event or circumstance occurs and instances where it does not. For example, the compositions described herein may optionally contain a bioactive agent, where the bioactive agent may or may not be present.

Throughout this specification, unless the context dictates otherwise, the word “comprise,” or variations such as “comprises” or “comprising,” will be understood to imply the inclusion of a stated element, integer, step, or group of elements, integers, or steps, but not the exclusion of any other element, integer, step, or group of elements, integers, or steps.

As used herein, the terms “about”, “substantially”, “nearly”, “around”, and “approximately” are used to provide flexibility to a numerical value and/or a numerical range endpoint by providing that an actual numerical value relative to a given numerical value, an actual numerical value relative to a given range of numerical values, or an actual range of numerical values relative to a given range of numerical values, may be “a little above” or “a little below” the given numerical value or an endpoint of the given range of numerical values without affecting the desired result. For purposes of the present disclosure, the terms “about”, “substantially”, “nearly”, “around”, and “approximately” should generally be taken to mean plus or minus 10% of the given numerical value stated or plus or minus 10% of the given range of numerical values provided. For example, a given numerical value of ‘about 250 μm’ should be considered to include actual numerical values of ‘225 μm’ to ‘275 μm’. As another example, a given numerical value of ‘about 1,000 μm’ should be considered to include actual numerical values of ‘900 μm’ to ‘1,100 μm’. Any provided numerical value or range of numerical values, whether or not it is modified by terms such as “about,” “substantially,” “nearly,” “around,” or “approximately,” all refer to and hereby disclose associated numerical values or ranges of numerical values thereabout, as described above.

As used herein, the term “admixing” is defined as mixing two or more components together so that there is no chemical reaction or physical interaction. The term “admixing” also includes the chemical reaction or physical interaction between the two or more components.

As used herein, a plurality of items, structural elements, compositional elements, and/or materials may be presented in a common list for convenience. However, these lists should be construed as though each member of the list is individually identified as a separate and unique member. Thus, no individual member of any such list should be construed as a de facto equivalent of any other member of the same list based solely on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an example, a numerical range of “about 1” to “about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, from about 1-about 3, from 1 to about 3, from about 1 to 3, etc., as well as 1, 2, 3, 4, and 5, individually. The same principle applies to ranges reciting only one numerical value as a minimum or maximum. The ranges should be interpreted as including endpoints (e.g., when a range of “from about 1 to 3” is recited, the range includes both of the endpoints 1 and 3 as well as the values in between). Furthermore, such an interpretation should apply regardless of the breadth or range of the characters being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference to each various individual combination and permutation of these compounds may not be explicitly disclosed, each is specifically contemplated and described herein. For example, if a hydrogel continuous phase is disclosed and discussed, and a number of different microgels are discussed, each and every combination of hydrogel continuous phase and microgel that is possible is specifically contemplated unless specifically indicated to the contrary. For example, if a class of hydrogel continuous phases A, B, and C are disclosed, as well as a class of microgels D, E, and F, and an example combination of A+D is disclosed, then even if each is not individually recited, each is individually and collectively contemplated. Thus, in this example, each of the combinations A+E, A+F, B+D, B+E, B+F, C+D, C+E, and C+F is specifically contemplated and should be considered from disclosure of A, B, and C; D, E, and F; and the example combination A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of the disclosure including, but not limited to, steps in methods of making and using the disclosed compositions. Thus, if there are a variety of additional steps that can be performed with any specific embodiment or combination of embodiments of the disclosed methods, each such composition is specifically contemplated and should be considered disclosed.

Described are systems, devices, compositions of matter, and methods associated with physical pest barriers. In some embodiments, a solid pest barrier can comprise or take the form of a cord, a ribbon, a sleeve, a landscaping edging barrier, a wall, a channel, a board, a chain, a comb, a spike, a tower, a band, a rope wick, a wiper, other suitable form factors, and/or the like.

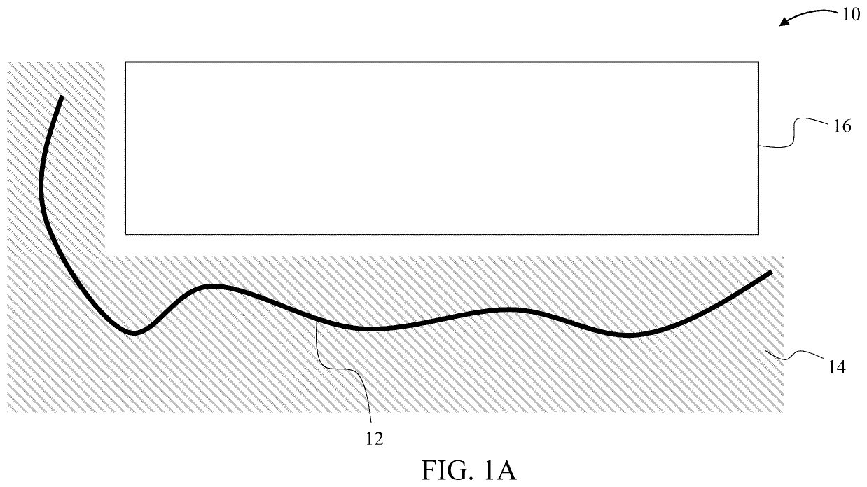

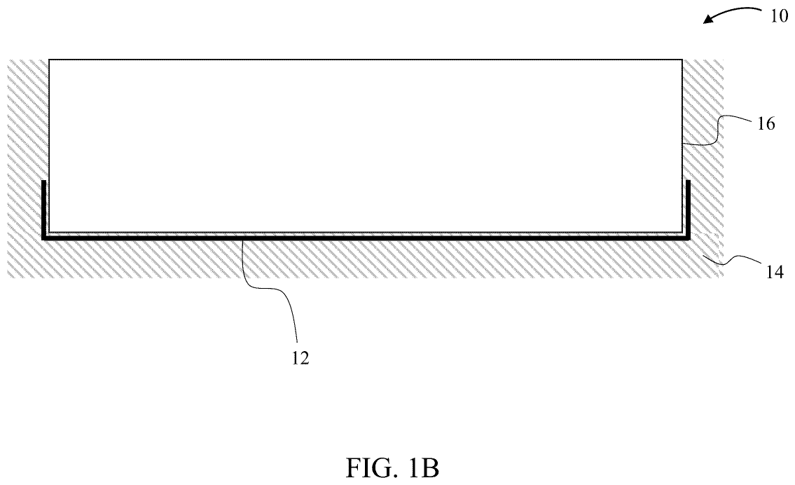

FIGS. 1A-1B illustrate a solid pest barrier system 10. The solid pest barrier system 10 comprises a solid pest barrier 12. In some embodiments, the solid pest barrier 12 can have a cord-like or rope-like form factor. In some embodiments, the solid pest barrier 12 can have a length defined between a first end and a second end. In some embodiments, the solid pest barrier 12 can be continuous, thereby preventing the formation of gaps longitudinally along the length of the solid pest barrier 12. Conversely, conventional pest management chemicals in liquid form or pellet form necessarily creates or maintains gaps along a length of deployment or dispersion.

In some embodiments, the solid pest barrier 12 can be deployed or placed within an application area 14, such as about a structure 16. As illustrated in FIG. 1A, the application area 14 can be or include an area located a non-zero distance from the structure 16. Additional or alternatively, such as illustrated in FIG. 1B, the application area 14 can be or include an area that is at least partially adjacent to or abutting the structure 16. In some embodiments, the application area 14 can be or comprise garden beds about a building, around outer edges of a foundation of a house, or the like. The solid pest barrier 12 can be deployed within the application area 14, which can be or comprise one or more locations within, on, adjunct to, or a non-zero distance from at least a portion of the structure 16. The structure 16 can be or comprise a dwelling, business, school, manufacturing facility, and/or the like. The solid pest barrier 12 can comprise one or more pest control chemical(s), such as one or more of: an insecticide, a pesticide, an herbicide, a fungicide, a rodenticide, a termiticide, and/or the like. In some embodiments, the solid pest barrier 12 can be configured (or dimensioned and configured) to release portions of the pest control chemical(s) over a period of time, referred to herein as a ‘desired application duration.’ In some embodiments, the pest control chemical(s) can be released from the solid pest barrier 12 at a linear rate or a non-linear rate during the desired application duration.

In some embodiments, the pest control chemical(s) used in the solid pest barrier 12 can be or comprise chemical or biological agents configured to deter, incapacitate, kill, or otherwise discourage pests. The pest control chemical(s) can include or comprise a broad range of substances, including insecticides, herbicides, fungicides, rodenticides, termiticides, and/or others. For example, the pest control chemical(s) can be or include organochlorines, such as Dichlorodiphenyltrichloroethane (DDT) or Gamma-Hexachlorocyclohexane (Lindane), organophosphates, such as malathion or parathion, or carbamates such as carbaryl or aldicarb, pyrethroids, such as permethrin or cypermethrin. The pest control chemical(s) can alternatively or additionally be or include herbicides including, e.g., phenoxy acids such as 2,4-D (2,4-Dichlorophenoxyacetic acid) or 2-Methyl-4-chlorophenoxyacetic acid (MCPA), triazines such as altrazine or simazine, glyphosates such as N-(phosphonomethyl)glycine), and/or dinitroanilines such as pendimethalin. The pest control chemical(s) can alternatively or additionally be or include fungicides, including, e.g., benzimidazoles such as carbendazim or thiophanate-methyl, dithiocarbamates such as mancozeb or zineb, and/or triazoles such as tebuconazole or propiconazole. The pest control chemical(s) can alternatively or additionally be or include rodenticides, such as anticoagulants, e.g., coumarins such as warfarin or brodifacoum and/or indandiones such as diphacinone or chlorophacione.

Also described herein are extrudable materials, such as polymers or the like, that can be extruded with such pest control chemical(s) to form the solid pest barrier 12, such as when the solid pest barrier 12 is formed via extrusion and has a cord-like form factor. Extrudable materials, such as monomers, dimers, polymers, cross-linkable materials, and/or the like, can be utilized in the formation of the solid pest barrier 12. In some embodiments, these materials must possess specific properties such as flexibility, durability, and compatibility with pest control chemical(s), depending upon the particular use case, application area 14, application duration, and pest control chemical(s) being used in the solid pest barrier 12. Said otherwise, based upon the particular pest control chemical or combination/mixture of pest control chemicals being used in the solid pest barrier, a particular matrix material or combination/mixture of matrix materials (e.g., polymers, curable materials, cross-linkable materials, gellable materials, and/or the like) can be chosen that will not adversely interact with the particular pest control chemical(s) chosen.

For example, polymers such as polyethylene (PE), polypropylene (PP), and polyvinyl chloride (PVC) may be used due to their excellent mechanical properties and ease of extrusion. Polyethylene, with its high chemical resistance and flexibility, can used in such applications requiring a robust barrier against pests. Polypropylene, known for its higher melting point and rigidity compared to polyethylene, may instead be more suitable for environments with higher temperature variations. Polyvinyl chloride, with its inherent flame retardancy and chemical resistance, is another useful material for extruding with pest control chemical(s) for use in the solid pest barrier 12 when intended to be deployed within or about the structure 16, such as a dwelling or the like, for which fire resistance/retardance is an important characteristic or aspect of the solid pest barrier 12.

Extrudable materials can be chosen/used that are degradable or biodegradable, which is increasingly important in the development of environmentally sustainable pest control solutions. Biodegradable polymers, such as polylactic acid (PLA), polyhydroxyalkanoates (PHA), and polycaprolactone (PCL), can additionally or alternatively be used in the extrudable matrix material due to their ability to break down naturally by microbial action into non-toxic byproducts like carbon dioxide, water, and biomass. For example, PLA, which can be derived from renewable resources like corn starch or sugarcane, is notable for its high strength and rigidity, making it suitable for applications requiring structural integrity. PHAs, which can be produced by bacterial fermentation of sugars or lipids, offer a wide range of mechanical properties and biodegradability in various environments, including soil and marine conditions. PCL, which is a synthetic aliphatic polyester, has a relatively low melting point and excellent compatibility with other polymers, enhancing its processability and biodegradability.

Alternatively, or in addition to biodegradable polymers, bio-based polymers derived from renewable resources can be used. These materials can be sourced from bio-based feedstocks, e.g., cellulosic feedstocks such as wood, agricultural residues, or dedicated energy crops. Bio-based polymers offer a sustainable alternative to petroleum-based polymers. For example, cellulose, the most abundant natural polymer, can be chemically modified to produce derivatives like cellulose acetate or regenerated cellulose, which exhibit excellent biodegradability and mechanical properties for purposes of extrusion as the solid pest barrier 12, such as that described herein. Lignin, another major component of lignocellulosic biomass, can be utilized to produce bio-based polyurethanes and other polymers for use in the solid pest barrier 12, such as described herein.

The extrusion of these biodegradable and bio-based polymers with pest control chemical(s) involves similar processes to those used with synthetic (non-bio-based and non-biodegradable) polymers. The polymer(s) and/or pest control chemical(s) can be melted or chemically liquified and mixed together. The mixture is then extruded, e.g., through a die, to form the solid pest barrier 12. The choice of polymer(s) and/or specific pest control chemical(s) used can be tailored to the desired application, ensuring effective pest control while minimizing environmental impact.

In addition to these base polymers, pest control chemical(s) can be incorporated into the polymer matrix, leading to increased efficacy of the solid pest barrier 12. The integration of pest control chemical(s) into the polymer matrix can be achieved through various methods, including but not limited to melt blending and solvent casting, which may help ensure a uniform distribution of the active agents (e.g., pest control chemical(s)) throughout the extruded material.

The extrusion process itself can involve the melting of the polymer(s) and the subsequent mixing of the pest control chemical(s) into the polymer melt, followed by the formation of the polymer material/pest control chemical(s) mixture into the solid pest barrier 12 having a cord-like form factor according to a particular dimensions and form factor of an extrusion die or dies used. This process requires precise control of temperature, pressure, and extrusion speed to ensure the uniformity and integrity of the solid pest barrier 12 being formed. The resulting extruded cord-like solid pest barrier 12 is then cooled and solidified, forming solid pest barrier 12 that is an effective pest control solution. The durability of the solid pest barrier 12 can be engineered to match a desired application duration or application period. In some embodiments, when the controlled degradation or weathering of the solid pest barrier 12 is at least a part of the means for releasing pest control chemical(s) into the application area 14, the solid pest barrier 12 can be engineered to have a known mechanical fragility or friability that leads to engineered impermanence of the solid pest barrier 12.

By way of example only, below are provided several examples of particular embodiments of the solid pest barrier 12 formed via extrusion of a mixture of one or more pest control chemical(s) and one or more matrix materials.

For example, a mixture of polyethylene (PE) and permethrin (C₂₁H₂₀Cl₂O₃) can be extruded to form a flexible, durable cord-like solid pest barrier 12. The PE is sufficiently biologically and toxicologically inert with respect to the availability and release of the permethrin, while the permethrin, a pyrethroid insecticide, provides effective protection against a wide range of insects during the lifespan of the solid pest barrier 12.

As another example, a mixture of polypropylene (PP) combined with tebuconazole (C₁₆H₂₂ClN₃O) can be extruded to form a somewhat more durable solid pest barrier 12. The PP offers relatively increased mechanical strength and chemical stability as a matrix material while the tebuconazole, a triazole fungicide, reduces and/or prevents fungal growth during the extended lifespan of the solid pest barrier 12.

In another example, a mixture of polyvinyl chloride (PVC) combined with chlorpyrifos (C₉H₁₁Cl₃NO₃PS) can be extruded to form a relatively more rigid solid pest barrier 12. The PVC offers significantly increased mechanical strength (in particular rigidity and hardness) relative to many other polymer matrix options, while the chlorpyrifos, an organophosphate insecticide, is an effective deterrent against various insect pests during the lifespan of the solid pest barrier 12, which in this particular example can be quite long relative to other examples described.

As another example, a mixture of polylactic acid (PLA) combined with deltramethrin (C₂₂H₁₉Br₂NO₃) can be extruded to form the solid pest barrier 12 with improved environmentally friendliness and which degrades over time (e.g., during the desired application duration). The PLA, a biodegradable polymer provides for the solid pest barrier 12 to be flexible and environmentally friendly, while the deltamethrin, a pyrethroid insecticide, provides for broad-spectrum insecticidal protection about the structure 16.

In another example, a mixture of one or more polyhydroxyalkanoates (PHA) combined with mancozeb (C₄H₆MnN₂S₄Zn) can be extruded to form the solid pest barrier 12 that is biodegradable and protects against fungal pathogens. The PHA is biodegradable, which allows for the engineered/controlled release of the mancozeb, while the mancozeb, a broad-spectrum dithiocarbamate fungicide, protects against fungal pathogens including leaf spot, scab, rust, a variety of blights, and/or the like.

As another example, a mixture of polycaprolactone (PCL) combined with cypermethrin (C₂₂H₁₉Cl₂NO₃) can be extruded to form the solid pest barrier 12 that is biodegradable and protects against insects entering or remaining within the application area 14. The PCL provides for increased flexibility, while still being biodegradable, which allows for a more customizable/bespoke deployment of the solid pest barrier 12 about the structure 16 or otherwise within the application area 14, while the cypermethrin, a synthetic pyrethroid insecticide, is an effective insecticide against insects including ants, cockroaches, ectoparasites, and the like. Cypermethrin is known to be moderately toxic to humans via dermal exposure or ingestion. In embodiments in which the solid pest barrier 12 includes cypermethrin, the form factor of the solid pest barrier 12 provides for significant reductions in human exposure risk as compared to the conventional form of cypermethrin, which is often commercially available in a powdery/chalky form. The only other form in which cypermethrin is commercially available currently is aerosol form, such as in products like Raid®, Ortho®, Combat®, or the like. In some embodiments, the solid pest barrier 12 can include a mixture of PCL and cypermethrin within an inner portion of the solid pest barrier 12 and a coating (e.g., thin coating) of just PCL about the outside of the inner portion of the solid pest barrier 12 - that way, when a user deploys the solid pest barrier 12 within the application area 14, the user will not come into direct dermal contact with the cypermethrin. Thereafter, during an initial portion of the desired application period/duration, the PCL coating about the inner portion of the solid pest barrier 12 can quickly biodegrade due to one or more environmental, biological, or microbial biodegradation factors, exposing the inner portion of the solid pest barrier 12 for exposure to pests during a reminder of the desired application period/duration.

In another example, a mixture of cellulose acetate, derived from cellulose, combined with imidacloprid (C₉H₁₀ClN₅O₂) can be extruded to form the solid pest barrier 12 that is bio-based and provides for long-lasting insect control. The cellulose acetate, which is bio-based, makes the solid pest barrier 12 at least partially bio-based, while the imidacloprid, a neonicotinoid insecticide, is a neonicotinoid that binds to nicotinic acetylcholine receptors of insects to block cholinergic transmission and paralyze the insect, providing for effective insecticidal protection about the structure 16.

As another example, a mixture of regenerated cellulose with propiconazole (C₁₅H₁₇Cl₂N₃O₂) can be extruded to form the solid pest barrier 12 that is bio-based, biodegradable, and an effective barrier against fungal infections. The regenerated cellulose, usually formed by dissolving cellulose in a soluble derivative and then regenerating it to form fibers, films, or polymeric structures, makes the solid pest barrier 12 at least partially bio-based and also biodegradable. The propiconazole, a triazole fungicide, is a demethylation inhibiting fungicide that binds with and inhibits the 14-alpha demethylase enzyme, thereby preventing fungal infections due to preventing the demethylation of an ergosterol precursor in most or all fungi.

In another example, a mixture of lignin-based polyurethane (PU) with warfarin (C₁₉H₁₆O₄) can be extruded to form the solid pest barrier 12 that is bio-based and provides for effective rodent control about the structure 16. The lignin-based PU is bio-based and makes the solid pest barrier 12 at least partially bio-based, while the warfarin, an anticoagulant rodenticide, effectively controls rodent populations within the application area 14.

As another example, a mixture of polybutylene succinate (PBS), a biodegradable polymer, with spinosad, which may contain a mixture of one or both of spinosyn A (C₄₁H₆₅NO₁₀) and spinosyn D (C₄₂H₆₇NO₁₀) can be extruded to create the solid pest barrier 12 that is environmentally friendly and which targets a wide range of insect pests. PBS is a biodegradable polymer, meaning that the solid pest barrier 12 can biodegrade/decompose within the application area 14 during the desired application duration. Spinosad, a natural insecticide derived from soil bacteria, is a broad-spectrum insecticide, derived from bacteria originally found in sugarcane, which causes neural damage to a broad array of insects in all different life stages and via ingestion or direct contact.

These examples illustrate the versatility of combining various polymers with pest control chemicals to create effective, durable, and environmentally sustainable pest barriers. Many other examples, combinations, and use cases are contemplated. Each combination can be tailored to specific pest control needs and environmental conditions, ensuring optimal performance and minimal ecological impact.

In some embodiments, the solid pest barrier 12 can comprise a plurality of capillaries, apertures, pores, vacuoles, interior spaces, cavities, holes, absorbent spaces, ducts, conduits, passageways, vessels, gaps, orifices, openings, stomates, and/or the like, thereby forming an inner volume having an inner surface area. The inner volume/inner surface area of the solid pest barrier 12 can be dimensioned and configured to releasably retain a volume or a mass of the pest control chemical. In some embodiments, the dimensions, form factor (shape), inner surface characteristics, interfacial chemistry, or other factors associated with the solid pest barrier 12 and/or the pest control chemical(s) disposed within the solid pest barrier 12 can be suitable to allow for controlled release of portions of the pest control chemical(s) from within the solid pest barrier 12 within the application area 14, during the desired application duration.

For example, in some embodiments the solid pest barrier 12 can comprise cavities, capillaries, pores, channels, microcavities, microcapillaries, micropores, microchannels, nanocavities, nanocapillaries, nanopores, nanochannels, and/or the like, which can collectively be referred to as “inner volume(s)” within the solid pest barrier 12. The inner volume(s) of the solid pest barrier 12 can be dimensioned and configured to draw pest control chemical(s) into the inner volume(s) of the solid pest barrier 12 using any suitable means, such as based on capillarity (e.g., the capillary action or capillary forces exerted on the pest control chemical(s) based upon the particular dimension(s) and/or form factor(s) of the cavities, capillaries, pores, channels, microcavities, microcapillaries, micropores, microchannels, nanocavities, nanocapillaries, nanopores, nanochannels, and/or the like within the inner volume(s) of the solid pest barrier 12.

In some embodiments, the capillary forces exerted on the pest control chemical(s) that retain the pest control chemical(s) within the inner volume(s) of the solid pest barrier 12 may be exerted only when a dimension (e.g., inner diameter) or an average dimension within the inner volume(s) is maintained within a particular range. This particular range may be associated with the particular pest control chemical(s) being used. Additionally or alternatively, this particular range may be associated with the particular material(s) used in the solid pest barrier 12. Additionally or alternatively, this particular range may be associated with the desired duration of retention of the pest control chemical(s) within the inner volume(s) of the solid pest barrier 12.

The controlled release of pest control chemical(s) from within the inner volume(s) of the solid pest barrier 12 can be caused by one or more of a variety of mechanisms, such as a preferential replacement of another material within the inner volume(s) of the solid pest barrier 12, a degradation of the materials used in the solid pest barrier 12, chemical or other changes to the pest control chemical(s) while retained within the inner volume(s) of the solid pest barrier 12, changes in temperature or humidity, weathering of the solid pest barrier 12 due to exposure to sunlight, wind, rain, and/or the like, thermal or moisture-based expansion or contraction of the solid pest barrier 12 or portions thereof over time, and/or the like.

For example, the solid pest barrier 12 can comprise a cable or cord formed from an expandable material (e.g., woven or wound material) that defines therewithin a plurality of microchannels that have an average inner diameter within a first average inner diameter range when the expandable material has a moisture content within a first moisture content range, while the expandable material has a second average inner diameter range larger than the first average inner diameter range when the moisture content of the expandable material is within a second moisture content range that is greater than the first moisture content range. Continuing with this example embodiment, prior to deployment, the solid pest barrier 12 can be formed from the expandable material, and the moisture content is controlled (e.g., reduced) to achieve a moisture content within the first moisture content range such that the microchannels contract to have an average inner diameter within the first average inner diameter range. Once the microchannels contract have contracted in order to have an average inner diameter within the first average inner diameter range, the expandable material can be exposed to (e.g., soaked in) the pest control chemical(s) and the microchannels within the expandable material of the solid pest barrier 12 can draw the pest control chemical(s) into the microchannels under capillary action (i.e., via capillary forces related to the dimensions of the microchannels), thereby making the solid pest barrier 12 deployable.

Continuing still with this example embodiment, after the deployable solid pest barrier 12 is deployed within the application area 14, an initial amount of the pest control chemical(s) may be released from the solid pest barrier 12 due to the physical nature of deployment, such as due to dropping or placing the solid pest barrier 12 onto the ground. After deployment, such as in humid or rainy environments, or when the application area 14 receives irrigation, stormwater runoff, or the like, the moisture content of the expandable material may rise over time, such as from a value within the first moisture content range to a moisture content value within the second moisture content range. This increase in moisture content within the expandable material can allow for the expansion of the expandable material from an average inner diameter of the microchannels from a value within the first average inner diameter range to a value within the second average inner diameter range, which may reduce capillarity in the microchannels within the solid pest barrier 12, thereby reducing the capillary forces exerted on the pest control chemical(s) releasably retained within the microchannels of the solid pest barrier 12. This reduced capillarity will lead to a release of at least part of the pest control chemical(s) releasably retained within some or all of the microchannels of the solid pest barrier 12.

In some embodiments, the solid pest barrier 12 may be reusable, while in other embodiments the solid pest barrier 12 may be or comprise a single use material. For example, the solid pest barrier 12 can be formed as a flexible cable or cord that is extruded from a solution that comprises the pest control chemical(s) and a degradable matrix configured to release the pest control chemical(s) from the solid pest barrier 12 within the application area 14 during the desired application duration.

In embodiments in which the solid pest barrier 12 is or comprises a single-use pest control barrier material, this single-use pest control barrier material can include a solid material configured to degrade over time to release pest control chemical(s). The pest control chemical(s) can be integrated into the solid pest barrier 12. In other embodiments, the pest control chemical(s) can be disposed within the solid pest barrier 12. For example, according to some embodiments the solid pest barrier 12 can comprise a cord or a cable dimensioned and configured to releasably retain a volume or mass of the pest control chemical(s).

According to some embodiments, the solid pest barrier 12 can be or comprise a solid pest barrier material that is configured to be replenished with pest control chemical(s) via a replenishing supply of the pest control chemical(s). As such, the solid pest control system 10 can additionally comprise a reservoir (not shown) that is configured to store the replenishing supply of the pest control chemical(s). The replenishing supply(ies) of the pest control chemical(s) can be provided to the solid pest barrier 12 iteratively, continuously, on-demand, or according to any other suitable schedule or approach.

In embodiments in which the solid pest barrier 12 is reusable, the solid pest barrier 12 can be recharged (e.g., replenished with a deployable mass or volume of the pest control chemical(s)), such as by taking up the solid pest barrier 12 and soaking the solid pest barrier 12 in the pest control chemical(s) or disposing the pest control chemical(s) onto an outer surface of the solid pest barrier 12. By placing the solid pest barrier 12 into contact with a replenishing supply of the pest control chemical(s), the pest control chemical(s) can soak into the solid pest barrier 12, e.g., due to capillary action caused by the dimensions and form factors of capillaries, channels, pores, or cavities within the solid pest barrier 12.

In some embodiments, the solid pest barrier 12 can comprise microcarriers or nanocarriers, such as polymeric spheres or capsules. The solid pest barrier 12 can be configured to release the microcarriers or nanocarriers, such as in response to the solid pest barrier 12 absorbing moisture, or in response to other environmental weathering/biodegradation. The microcarriers or nanocarriers can comprise the pest control chemical(s) therein such that when the microcarriers or nanocarriers are released from the solid pest barrier 12, the pest control chemical(s) can be spatially dispersed within the microcarriers or nanocarriers, which can themselves biodegrade after spatial dispersion of the same across the application area 14, thereby allowing for a more spatially distributed release of the pest control chemical(s) across the application area 14.

In some embodiments, the solid pest barrier 12 can be or comprise a nanoporous material that allows for slow wicking of the pest control chemical(s) from nanopores over time, when the material is wetted, upon exposure to sunlight, wind, rain, irrigation water, when contacted by a pest, and/or the like.

The solid pest barrier 12 can be deployed by either a professional or commercial pesticide/insecticide specialist or a layperson. The need for the solid pest barrier 12 to be deployed by a professional rather than a layperson may depend on several factors, such as exposure risk of the particular pest control chemical(s) being used in the solid pest barrier 12, the difficulty or complexity of deployment, the risk of damage to the solid pest barrier 12 during deployment, the risk of ineffectiveness of the solid pest barrier 12 due to incorrect deployment, and/or the like.

The solid pest barrier 12, when deployed to within the application area 14, may be positioned at least partially on the ground around the structure 16. The solid pest barrier 12 may be positioned at least partially under the ground around the structure 16. The solid pest barrier 12 may be positioned a non-zero distance away from an exterior wall of the structure 16, a non-zero distance away from an outside of a foundation of the structure 16, a non-zero distance away from exterior landscaping or hardscaping located adjacent to or nearby the structure 16, or a non-zero distance away from any other suitable point or portion of the structure 16. The solid pest barrier 12 may be at least partially coupled to or supported by the structure 16.

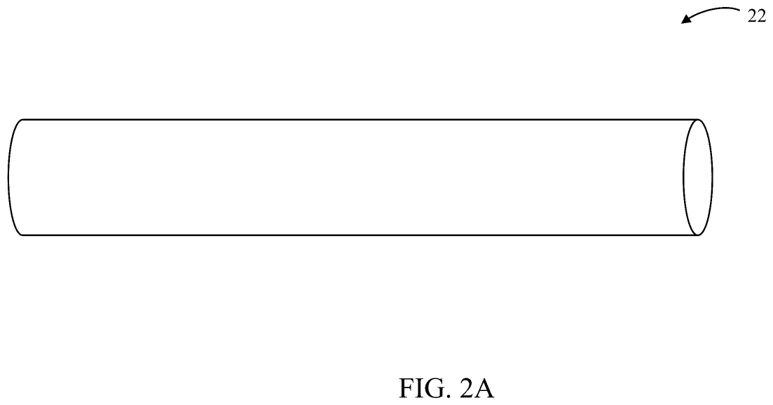

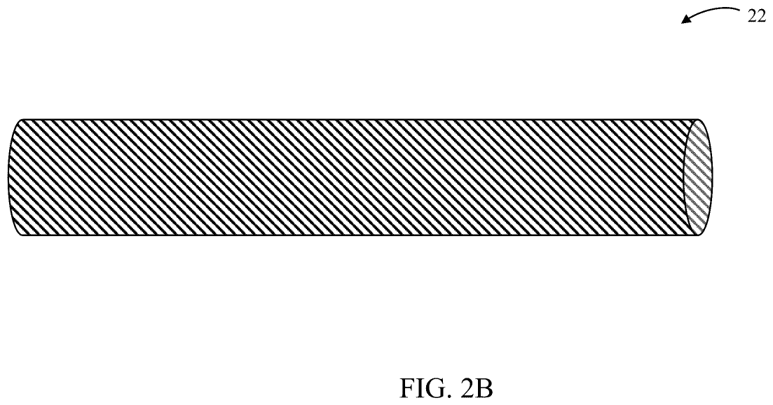

FIGS. 2A and 2B illustrate examples of a solid pest barrier 22. As illustrated in FIG. 2A, the solid pest barrier 22 can be substantially non-porous or otherwise solid in nature. As illustrated in FIG. 2B, the solid pest barrier 22 can be at least partially porous, textured, or otherwise configured to retain a material or chemical within or on the solid pest barrier 22.

In some embodiments, the solid pest barrier 22 can be made by forming a mixture of the pest control chemical(s) and an extrudable material, such as a polymeric or monomeric material, and extruding the mixture to form the solid pest barrier 22. The extrudable material can be biodegradable, weatherable, friable, or otherwise configured to physically and/or chemically degrade over time, such as in response to one or more environmental elements or stimuli. For example, in some embodiments, the extrudable material can comprise a biopolymer that is configured to biodegrade at a known rate in response to exposure to sunlight. In some embodiments, the extrudable material can comprise a biopolymer that is configured to biodegrade at a known rate in response to exposure to moisture, such as in response to exposure to humidity in the air, rainwater, irrigation water, moisture in the soil, and/or the like. In some embodiments, the extrudable material can comprise a biopolymer that is configured to biodegrade at a predictable rate that is independent from, or at least partially independent from, environmental elements or stimuli such as sunlight exposure, moisture exposure, wind, physical impacts, pest interactions, and/or the like.

In other embodiments, the solid pest barrier 22 can be made by forming two or more strands of a flexible, porous material, impregnating the two or more strands of flexible, porous material with the pest control chemical(s), and then weaving or otherwise interleaving the two or more strands of flexible, porous material together to form a woven or otherwise interleaved cord-like or rope-like form factor or structure. Once woven or otherwise interleaved, a plurality of channels or the like can be formed between the two or more strands of flexible, porous material. The plurality of channels can be left empty such that when the solid pest barrier 22 is deployed, moisture (e.g., from rainwater, irrigation water, humidity in the air, soil moisture adsorption, and/or the like) can be drawn into the plurality of channels, which may cause expansion of the solid pest barrier 22, which can cause at least partial release of the pest control chemical(s) from within the pores of the two or more strands of flexible, porous material.

In still other embodiments, the solid pest barrier 22 can be made by forming two or more strands of a flexible, porous material, and then weaving or otherwise interleaving the two or more strands of flexible, porous material together to form a woven or otherwise interleaved cord-like or rope-like form factor or structure. Once woven or otherwise interleaved, a plurality of channels or the like can be formed between the two or more strands of flexible, porous material. Thereafter, the plurality of channels of the woven cord-like or rope-like form factor or structure of strands of flexible, porous material can be impregnated with the pest control chemical(s) to form the solid pest barrier 22. When the solid pest barrier 22 is deployed, moisture (e.g., from rainwater, irrigation water, humidity in the air, soil moisture adsorption, and/or the like) can be drawn into the pores of the two or more strands of flexible, porous material, which may cause expansion of strands of flexible, porous material, which can cause a change in the dimensions/form factor of the plurality of channels, thereby causing at least partial release of the pest control chemical(s) from within the plurality of channels between the two or more strands of flexible, porous material in the solid pest barrier 22.

The solid pest barrier 22 can be or comprise a material that is absorbent, porous, or is otherwise dimensioned and configured to receive (e.g., releasably receive) a mass or a volume of pest control chemical(s). The solid pest barrier 22 can be or comprise a material that is flexible such that the solid pest barrier 22 is configured to be deployed in a large number of different configurations, about a large number of different structures (e.g., such as how solid pest barrier 12 is deployed about structure 16 in FIGS. 1A and 1B). The solid pest barrier 22 can be or comprise a durable material such that the solid pest barrier 22 is deployable about a structure (e.g., 16) for a sufficiently long period of time such that the pest control chemical(s) can be released, thereby reducing or eliminating targeted pests about or within the structure for a desired duration.

The solid pest barrier 22 can be or comprise a nonwoven material (e.g., extruded material) having apertures, pores, cavities, channels, or the like formed therein, which can be formed at the time of manufacturing/formation of the nonwoven material (e.g., via selectively occlusive extrusion), or can be formed by selective removal of material from the nonwoven material after manufacturing/formation thereof.

According to another embodiment, the solid pest barrier 22 can comprise a biodegradable material having a substantially cord-like or rope-like form factor with the pest control chemical(s) being disposed within the biodegradable material. In some embodiments, the one or more pest control chemicals are configured to repel or cause mortality for one or more undesirable pests upon contact or ingestion by the one or more undesirable pests of the one or more pest control chemicals. In some embodiments, the biodegradable material is configured to biodegrade during a desired pest control period following deployment of the solid pest barrier 22 within an application area (e.g., 14). In some embodiments, during the desired pest control duration following deployment of the solid pest barrier 22 within the application area, as the biodegradable material biodegrades, some or all of the one or more pest control chemicals disposed within the biodegradable material is released from the solid pest barrier 22, thereby facilitating exposure of the one or more pest control chemicals to the one or more undesirable pests.

In some embodiments, the biodegradable material is configured to at biodegrade in response to exposure to one or more environmental elements. In some embodiments, the one or more environmental elements comprise at least one of: sunlight, irrigation water, rain, humidity, wind, heat, cold, or combinations thereof. In some embodiments, the biodegradable material is configured to biodegrade at a rate that is sufficient such that the biodegradable material fully biodegrades at an end of the desired pest control duration following deployment of the solid pest barrier 22 within the application area. In some embodiments, the decomposable material comprises polyglycolic acid, polylactic acid, polycaprolactone (PCL), and poly(lactide-co-glycolide) (PLGA), or combinations thereof.

According to another embodiment, the solid pest barrier 22 can be provided that comprises a flexible woven material having a substantially cord-like or rope-like form factor. In some embodiments, the flexible woven material comprises a plurality of flexible material elements that are woven together, the plurality of flexible material elements having a substantially rope strand-like form factor. In some embodiments, a respective flexible material element of the plurality of flexible material elements comprises a first plurality of pores within the flexible material element. In some embodiments, the flexible woven material defines a second plurality of pores between the plurality of flexible material elements woven together to form the flexible woven material. In some embodiments, the first plurality of pores within respective of the plurality of flexible material elements are dimensioned and configured to releasably retain the pest control chemical(s) within the first plurality of pores. In some embodiments, the one or more pest control chemicals are configured to repel or cause mortality for one or more undesirable pests upon contact or ingestion by the one or more undesirable pests of the one or more pest control chemicals. In some embodiments, the second plurality of pores between the plurality of flexible material elements within the flexible woven material are substantially empty prior to deployment of the solid pest barrier 22. In some embodiments, in an instance in which an aqueous liquid is absorbed into some or all of the second plurality of pores between the plurality of flexible material elements within the flexible woven material, at least a portion of the one or more pest control chemicals releasably retained within the first plurality of pores within respective of the plurality of flexible material elements are released from the solid pest barrier 22, thereby facilitating exposure of the one or more pest control chemicals to the one or more undesirable pests.

In some embodiments, the flexible woven material has a first coefficient of moisture expansion within a first predetermined range, and wherein respective of the flexible material elements have a second coefficient of moisture expansion within a second predetermined range. In some embodiments, the second plurality of pores defined within respective of the plurality of flexible material elements are dimensioned and configured to releasably retain the one or more pest control chemicals within the second plurality of pores using capillary action.

In some embodiments, the solid pest barrier 22 can be formed by forming a plurality of flexible material elements, the plurality of flexible material elements having a substantially rope strand-like form factor, wherein respective of the plurality of flexible material elements comprise a first plurality of pores defined therein. The method of forming the solid pest barrier 22 can further comprise disposing one or more pest control chemicals into the first plurality of pores of respective of the plurality of flexible material elements. In some embodiments, the one or more pest control chemicals are configured to repel or cause mortality for one or more undesirable pests upon contact or ingestion by the one or more undesirable pests of the one or more pest control chemicals. In some embodiments, the first plurality of pores are dimensioned and configured to releasably retain the one or more pest control chemicals therein. In some embodiments, the method of forming the solid pest barrier 22 can further comprise weaving the plurality of flexible material elements together to form the solid pest barrier 22. In some embodiments, the solid pest barrier 22 has a substantially cord-like or rope-like form factor. In some embodiments, the solid pest barrier 22 defines a second plurality of pores between the plurality of flexible material elements once woven together. In some embodiments, the second plurality of pores between the plurality of flexible material elements within the solid pest barrier 22 are substantially empty. In some embodiments, in an instance in which an aqueous liquid is absorbed into some or all of the second plurality of pores between the plurality of flexible material elements within the solid pest barrier 22, the solid pest barrier 22 is configured to release at least a portion of the one or more pest control chemicals releasably retained within the first plurality of pores within respective of the plurality of flexible material elements, thereby facilitating exposure of the one or more pest control chemicals to the one or more undesirable pests.

In some embodiments, the solid pest barrier 22 has a first coefficient of moisture expansion within a first predetermined range, and wherein respective of the flexible material elements have a second coefficient of moisture expansion within a second predetermined range. In some embodiments, the second plurality of pores defined within respective of the plurality of flexible material elements are dimensioned and configured to releasably retain the one or more pest control chemicals within the second plurality of pores using capillary action.

In some embodiments, the solid pest barrier 22 can be formed according to a method that comprises mixing one or more pest control chemicals into a biodegradable material to form an extrudable mixture and extruding the extrudable mixture to form the solid pest barrier 22 having a substantially cord-like or rope-like form factor. In some embodiments, the one or more pest control chemicals are configured to repel or cause mortality for one or more undesirable pests upon contact or ingestion by the one or more undesirable pests of the one or more pest control chemicals. In some embodiments, the biodegradable material is configured to biodegrade during a desired pest control period following deployment of the solid pest barrier 22 within an application area (e.g., 14). In some embodiments, during the desired pest control duration following deployment of the solid pest barrier 22 within the application area, as the biodegradable material biodegrades, some or all of the one or more pest control chemicals disposed within the biodegradable material is released from the solid pest barrier 22, thereby facilitating exposure of the one or more pest control chemicals to the one or more undesirable pests.

In some embodiments, the biodegradable material is configured to at biodegrade in response to exposure to one or more environmental elements. In some embodiments, the one or more environmental elements comprise at least one of: sunlight, irrigation water, rain, humidity, wind, heat, cold, or combinations thereof. In some embodiments, the biodegradable material is configured to biodegrade at a rate that is sufficient such that the biodegradable material fully biodegrades at an end of the desired pest control duration following deployment of the solid pest barrier 22 within the application area. In some embodiments, the decomposable material comprises polyglycolic acid, polylactic acid, polycaprolactone (PCL), and poly(lactide-co-glycolide) (PLGA), or combinations thereof.

According to another embodiment, the solid pest barrier 22 can be formed according to a method that comprises forming a substantially cord-like or rope-like material defining therein a plurality of microchannels having an average largest diameter within a predetermined range; and disposing one or more pest control chemicals within the plurality of microchannels defined within the substantially cord-like or rope-like material to form the solid pest barrier 22. In some embodiments, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, the substantially cord-like or rope-like material is configured to become increasingly friable during a desired pest control period following deployment of the solid pest barrier 22 within an application area (e.g., 14). In some embodiments, during the desired pest control duration following deployment of the solid pest barrier 22 within the application area, as the substantially cord-like or rope-like material becomes increasingly friable, the plurality of microchannels are dimensioned and configured to release some or all of the one or more pest control chemicals previously retained within the plurality of microchannels, causing release of at least a portion of the one or more pest control chemicals from the solid pest barrier 22, thereby facilitating exposure of the one or more pest control chemicals to the one or more undesirable pests.

In some embodiments, the porous flexible material is configured to become increasingly friable in response to exposure to one or more environmental elements. In some embodiments, the one or more environmental elements comprise at least one of: sunlight, irrigation water, rain, humidity, wind, heat, cold, or combinations thereof.

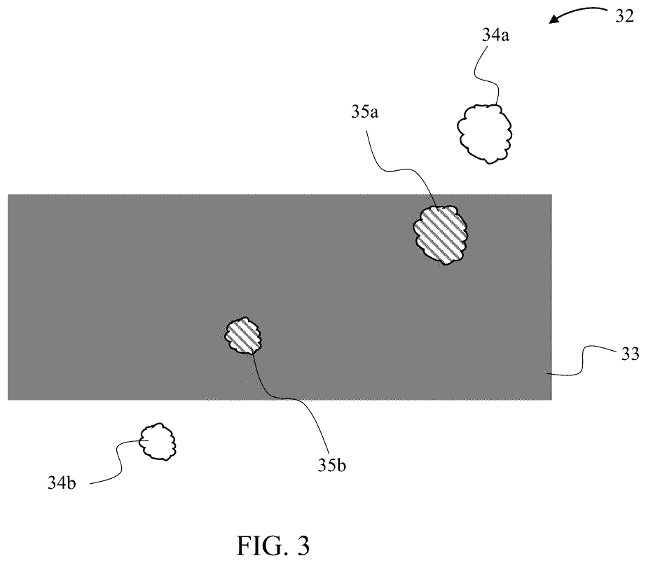

Referring now to FIG. 3, a solid pest barrier 32 is illustrated, according to an embodiment. The solid pest barrier 32 can comprise a pest control chemical/matrix material mixture 33 formed into a cord-like (or generally columnar) form factor. Upon deployment of the solid pest barrier 32 into an application area (e.g., 14), such as on or about a structure (e.g., 16), the solid pest barrier 32 can remain in place after deployment for a period of time (i.e., an application duration). During the application duration, the solid pest barrier 32 can be exposed to environmental factors or elements, such as heat, cold, humidity, moisture, precipitation, rain, snow, ice, surface runoff, thermal expansion, thermal contraction, moisture expansion, moisture contraction, and/or the like.

When the solid pest barrier 32 is exposed to one or more environmental factors or elements, the solid pest barrier 32 can partially degrade or weather, causing portions of the pest control chemical/matrix material mixture 33 to separate from a remainder of the pest control chemical/matrix material mixture 33. For example, as illustrated in FIG. 3, one or more surface portions 34a, 34b of the pest control chemical/matrix material mixture 33 can break off, erode away from, or otherwise separate from the remainder of the pest control chemical/matrix material mixture 33, leaving one or more inner portions 35a, 35b of the remainder of the pest control chemical/matrix material mixture 33 exposed.

In some embodiments, the solid pest barrier 32 can be formed in such a way that a surface portion of the pest control chemical/matrix material mixture 33 contains a relatively lower concentration of the pest control chemical relative to other portions (e.g., a remainder) of the pest control chemical/matrix material mixture 33. Said otherwise, an inner portion (e.g., 35a, 35c) of the pest control chemical/matrix material mixture 33 of the solid pest barrier 32 can contain a first concentration of the pest control chemical relative to the matrix material in the pest control chemical/matrix material mixture 33, while an outer portion (e.g., 34a 34b) of the pest control chemical/matrix material mixture 33 can contain a second concentration of the pest control chemical relative to the matrix material in the pest control chemical/matrix material mixture 33, where the first concentration of the pest control chemical in the inner portion of the pest control chemical/matrix material mixture 33 is higher than the pest control chemical in the outer portion of the pest control chemical/matrix material mixture 33.

In some embodiments, once the one or more outer portions 34a 34b of the pest control chemical/matrix material mixture 33 are separated from a remainder of the pest control chemical/matrix material mixture 33, the one or more inner portions 35a, 35b of the remainder of the pest control chemical/matrix material mixture 33 are exposed to an outside of the solid pest barrier 32. Since the outer portions (e.g., 34a, 34b) contain a concentration of the pest control chemical, the solid pest barrier 32 can be effective (e.g., as a pest deterring or eradication device), immediately upon deployment of the solid pest barrier 32 into an application area (e.g., 14). Then, during the subsequent application duration, the solid pest barrier 32 remains effective (e.g., as a pest deterring or eradication device) due to weathering/erosion of the pest control chemical/matrix material mixture 33, which makes the potion(s) of the pest control chemical within the inner portions (e.g., 35a, 35b) of the pest control chemical/matrix material mixture 33 available to pests that may interact with the solid pest barrier 32. In other embodiments, upon weathering of the pest control chemical/matrix material mixture 33, at least a portion of the pest control chemical within the inner portions (e.g., 35a, 35b) of the pest control chemical/matrix material mixture 33 and/or at least a portion of the pest control chemical within the eroded/separated outer portions (e.g., 34a, 34b) of the pest control chemical/matrix material mixture 33 to migrate out of the portions (e.g., 34a, 34b, 35a, 35b) of the pest control chemical/matrix material mixture 33, thereby making portions of the pest control chemical available to pests that interact with the pest control chemical that separate from/erode from the solid pest barrier 32.

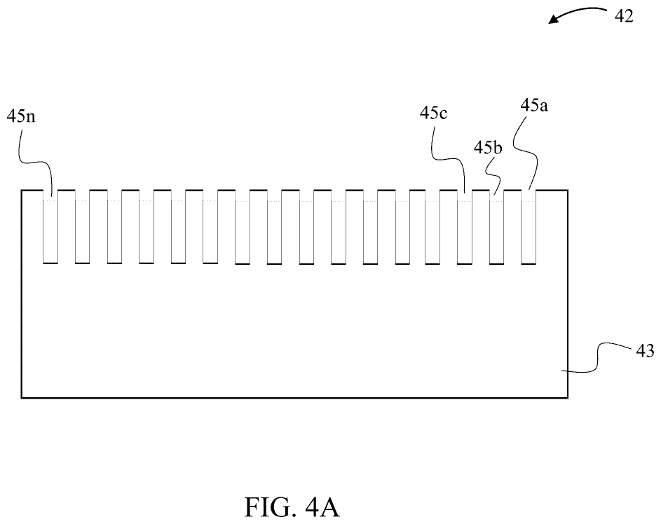

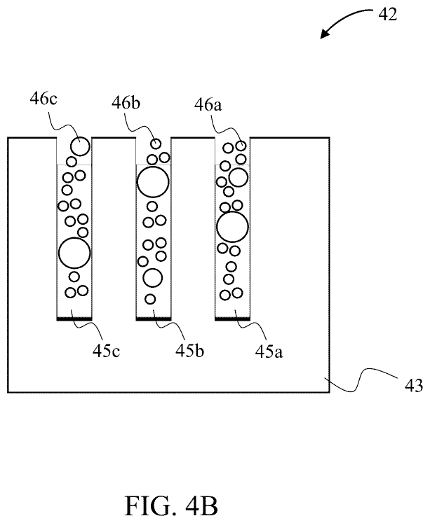

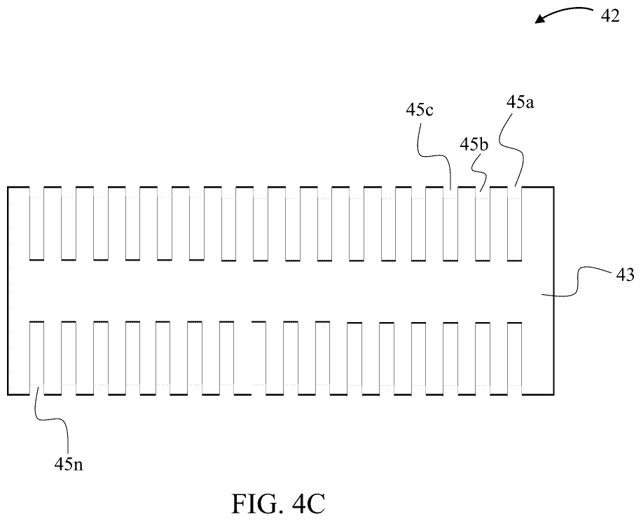

Referring now to FIGS. 4A-4C, a solid pest barrier 42 is illustrated, according to some embodiments, which comprises a pest control chemical retention material 43. As illustrated in FIG. 4A, the pest control chemical retention material 43 can comprise or define a plurality of channels 45a, 45b, 45c . . . 45n defined therein. The ‘n’ in 45n refers to an ‘n^{th}’ channel, where n is any integer greater than the preceding number of channels specifically identified using element numbering in FIGS. 4A-4C.

A cutout of a portion of the solid pest barrier 42 is illustrated in FIG. 4B, which shows at least a portion of the plurality of channels 45a, 45b, 45c . . . 45n defined in the pest control chemical retention material 43 are, respectively, impregnated with a plurality of portions of pest control chemical(s) 46a, 46b, 46c.

In some embodiments, such as illustrated in FIG. 4C, the plurality of channels 45a, 45b, 45c . . . 45n defined in the pest control chemical retention material 43 can be formed on multiple sides of the pest control chemical retention material 43. This may be helpful because, after deployment of the solid pest barrier 42, if release of the pest control chemical(s) 46a, 46b, 46c from the plurality of channels 45a, 45b, 45c . . . 45n defined in the pest control chemical retention material 43 is initiated or catalyzed by exposure to sunlight, rainwater, irrigation water, or the like, then an initial deployed orientation of the solid pest barrier 42 may partially control how quickly/effectively the pest control chemical(s) 46a, 46b, 46c are released from the plurality of channels 45a, 45b, 45c . . . 45n. The initial deployed orientation, for example, for a solid pest barrier 42 having the plurality of channels 45a, 45b, 45c . . . 45n defined only on one side of the solid pest barrier 42, may need to be deployed in an initial deployed orientation in which the openings of the plurality of channels 45a, 45b, 45c . . . 45n is exposed to the environmental factors that will cause engineered release of the pest control chemical(s) 46a, 46b, 46c from the plurality of channels 45a, 45b, 45c . . . 45n.

Additionally or alternatively, after deployment of the solid pest barrier 42 within the application area (e.g., 14), factors, such as other human activity in the application area or environmental factors such as wind, rainwater runoff, or the like, can cause a change of the solid pest barrier 42 from the initial deployed orientation to a secondary orientation, such that even if the solid pest barrier 42 is properly deployed to achieve proper engineered release of the pest control chemical(s) 46a, 46b, 46c from the plurality of channels 45a, 45b, 45c . . . 45n, the change from the initial to the secondary orientation after deployment of the solid pest barrier 42 can have the same detrimental effect on effectiveness of the solid pest barrier 42.

However, if the plurality of channels 45a, 45b, 45c . . . 45n are formed on more than one side or surface of the solid pest barrier 42, then the effectiveness of the solid pest barrier 42 may be less tied to deployment orientation of the solid pest barrier 42.

In some embodiments, the solid pest barrier 42 can comprise or take the form of a cord, a ribbon, a sleeve, a landscaping edging barrier, a wall, a channel, a board, a chain, a comb, a spike, a tower, a band, a rope wick, a wiper, other suitable form factors, and/or the like.

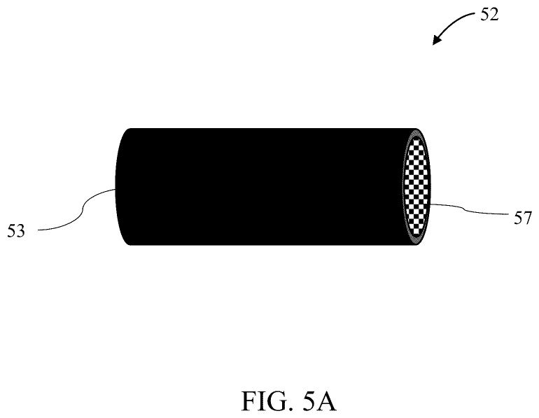

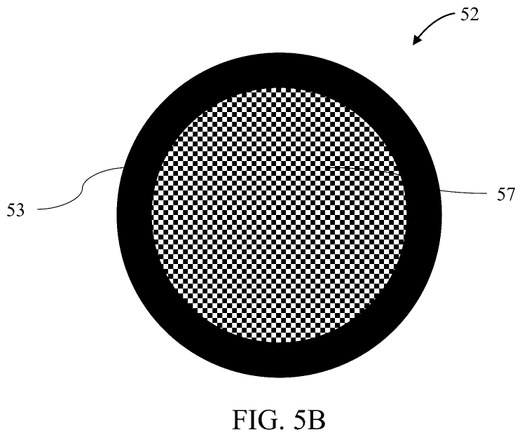

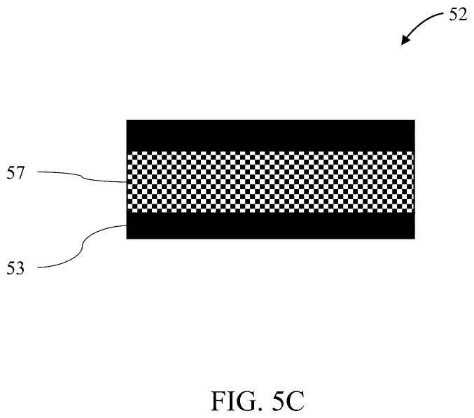

Referring now to FIGS. 5A-5C, an example is illustrated of a solid pest barrier 52 that has a substantially columnar form factor. The solid pest barrier 52 comprises a pest control chemical retention material 53 that is configured to temporarily retain pest control chemical(s) within the solid pest barrier 52. FIG. 5A illustrates the solid pest barrier 52 from a perspective view, FIG. 5B illustrates the solid pest barrier 52 from a side or end-on view, and FIG. 5C illustrates the solid pest barrier 52 from a cutaway side-view.

In some embodiments, the solid pest barrier 52 can comprise a porous flexible material 57 having a substantially columnar form factor, the porous flexible material 57 defining therein a plurality of microchannels, and one or more pest control chemicals disposed within the plurality of microchannels. In some embodiments, the porous flexible material 57 has a coefficient of moisture expansion within a predetermined range such that the plurality of microchannels have a first average diameter within a first average diameter range when the porous flexible material 57 is in a substantially dry configuration. In some embodiments, the plurality of microchannels have a second average diameter within a second average diameter range when the porous flexible material 57 is in a wetted configuration. In some embodiments, the second average diameter range is larger than the first average diameter range. In some embodiments, when the porous flexible material 57 is in the substantially dry configuration and has the first average diameter, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, when the porous flexible material 57 is in the wetted configuration and the plurality of microchannels have the second average diameter, the plurality of microchannels are dimensioned and configured to release some or all of the one or more pest control chemicals previously retained within the plurality of microchannels. In some embodiments, this may cause release of at least a portion of the one or more pest control chemicals from the solid pest barrier 52, thereby facilitating exposure of the one or more pest control chemicals to the one or more undesirable pests.

According to another embodiment, the porous flexible material 57 can be configured to become increasingly friable during a desired pest control period following deployment of the solid pest barrier 52 within an application area (e.g., 14). In some embodiments, during the desired pest control duration following deployment of the solid pest barrier 52 within the application area, as the porous flexible material 57 becomes increasingly friable, the plurality of microchannels are dimensioned and configured to release some or all of the one or more pest control chemicals previously retained within the plurality of microchannels. This may cause release of at least a portion of the one or more pest control chemicals from the solid pest barrier 52, thereby facilitating exposure of the one or more pest control chemicals to the one or more undesirable pests.

In some embodiments, the porous flexible material 57 is configured to become increasingly friable in response to exposure to one or more environmental elements. In some embodiments, the one or more environmental elements comprise at least one of: sunlight, irrigation water, rain, humidity, wind, heat, cold, or combinations thereof.

While the solid pest barrier 52 is illustrated in FIGS. 5A-5C with the porous flexible material 57 being encapsulated within the pest control chemical retention material 53, in alternative embodiments, the solid pest barrier 52 can comprise just the porous flexible material 57 as described above, without being encapsulated within the pest control chemical retention material 53.

In some embodiments, the solid pest barrier 52 can be formed using a method that comprises forming the porous flexible material 57 having the substantially columnar form factor, the porous flexible material 57 defining therein the plurality of microchannels; and disposing one or more pest control chemicals within the plurality of microchannels to form the solid pest barrier 52. In some embodiments, the porous flexible material 57 has a coefficient of moisture expansion within a predetermined range such that the plurality of microchannels have a first average diameter within a first average diameter range when the porous flexible material 57 is in a substantially dry configuration. In some embodiments, the plurality of microchannels have a second average diameter within a second average diameter range when the porous flexible material 57 is in a wetted configuration, the second average diameter range being larger than the first average diameter range. In some embodiments, when the porous flexible material 57 is in the substantially dry configuration and has the first average diameter, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, when the porous flexible material 57 is in the wetted configuration and the plurality of microchannels have the second average diameter, the plurality of microchannels are dimensioned and configured to release some or all of the one or more pest control chemicals previously retained within the plurality of microchannels, causing release of at least a portion of the one or more pest control chemicals from the solid pest barrier 52, thereby facilitating exposure of the one or more pest control chemicals to the one or more undesirable pests.

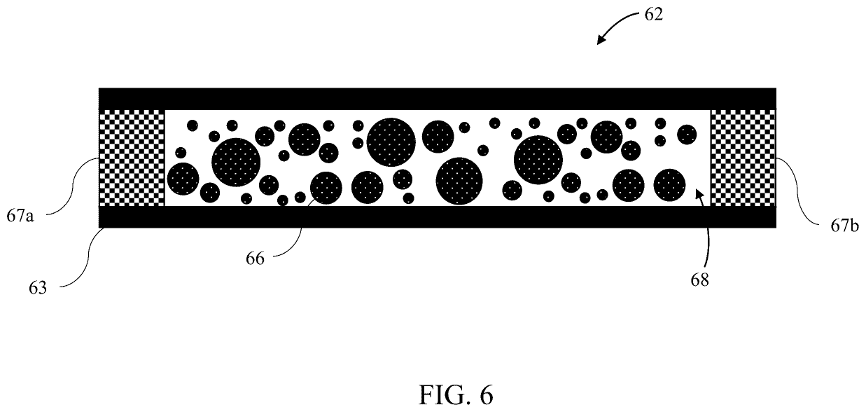

Referring now to FIG. 6, an alternative embodiment of a solid pest barrier 62 is illustrated. The solid pest barrier 62 in FIG. 5 comprises a pest control chemical retention material 63 that defines an inner volume 68 within the pest control chemical retention material 63. The inner volume 68 can be further defined by two or more pest control chemical permeable caps 67a, 67b. The two or more pest control chemical permeable caps 67a, 67b can be disposed partially within the inner volume 68 of the solid pest barrier 62 via apertures at each end of the pest control chemical retention material 63. The two or more pest control chemical permeable caps 67a, 67b can be selectively permeable to pest control chemical(s) 66.

The inner volume 68 of the solid pest barrier 62 can be configured to releasably receive the pest control chemical(s) 66, such as an insecticide, a pesticide, an herbicide, and/or the like. The solid pest barrier 62 can comprise a single chamber defining the inner volume 68. In some embodiments, the inner chamber can be configured to releasably retain a supply of the pest control chemical(s) 66. Alternatively, the solid pest barrier 62 can comprise a plurality of apertures, pores, capillaries, cavities, channels, or the like that are configured to releasably retain a supply of the pest control chemical(s) 66.

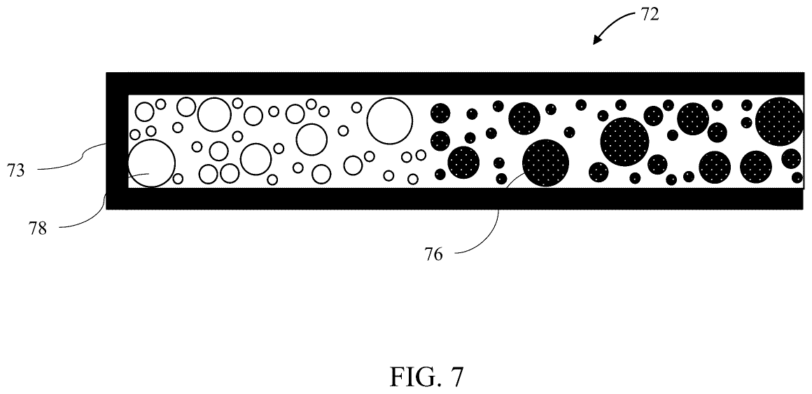

Referring now to FIG. 7, an alternative embodiment of a solid pest barrier 72 is illustrated. The solid pest barrier 72 in FIG. 7 comprises a pest control chemical retention material 73 that defines inner volumes 78 within the pest control chemical retention material 73. The inner volumes 78 of the solid pest barrier 72 can be configured to releasably receive the pest control chemical(s) 76, such as an insecticide, a pesticide, an herbicide, and/or the like. The solid pest barrier 72 can comprise a plurality of pores defining the inner volumes 78. In some embodiments, the inner chamber can be configured to releasably retain a supply of the pest control chemical(s) 76. Alternatively, the solid pest barrier 72 can comprise a plurality of apertures, pores, capillaries, cavities, channels, or the like that are configured to releasably retain a supply of the pest control chemical(s) 76.

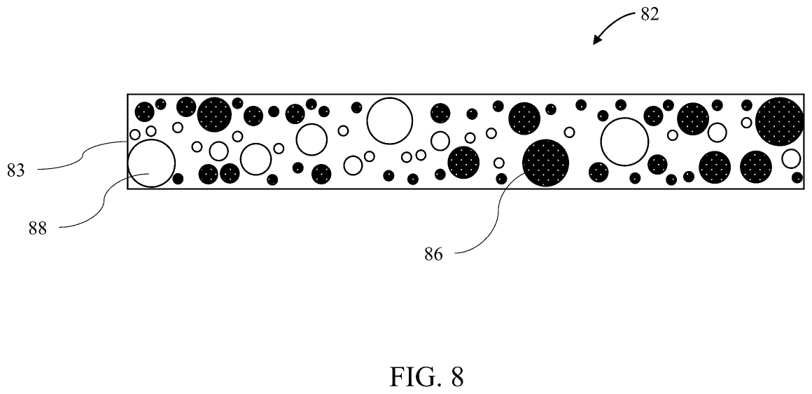

Referring now to FIG. 8, an alternative embodiment of a solid pest barrier 82 is illustrated. The solid pest barrier 82 in FIG. 8 comprises a pest control chemical retention material 83 that comprises inner volumes 88 within the pest control chemical retention material 83. The inner volumes 88 of the solid pest barrier 82 can be configured to releasably receive the pest control chemical(s) 86, such as an insecticide, a pesticide, an herbicide, and/or the like. The solid pest barrier 82 can comprise a plurality of pores defining the inner volumes 88. In some embodiments, the inner chamber can be configured to releasably retain a supply of the pest control chemical(s) 86. Alternatively, the solid pest barrier 82 can comprise a plurality of apertures, pores, capillaries, cavities, channels, or the like that are configured to releasably retain a supply of the pest control chemical(s) 86.

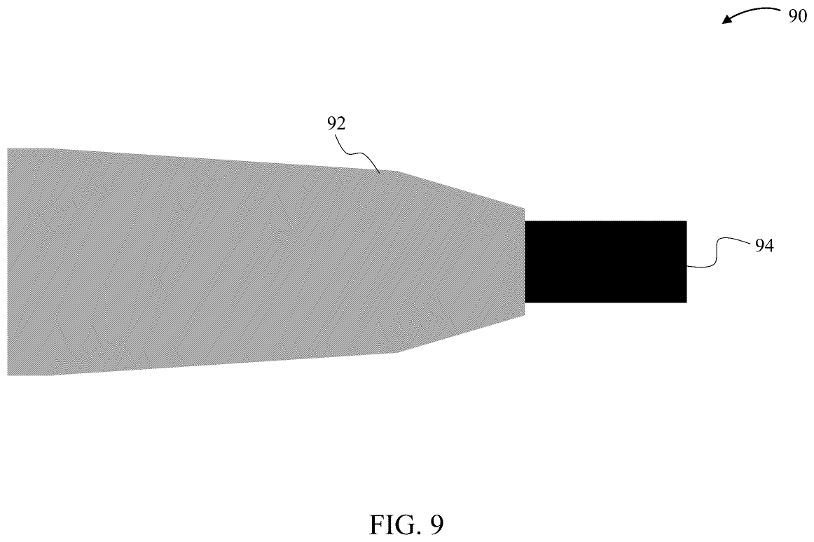

Referring now to FIG. 9, a process 90 for deployment of a solid pest barrier 92 using a dispensing tip 94 is illustrated, according to embodiments of the present disclosure. The solid pest barrier 92 can comprise a curable fluid matrix material and one or more pest control chemicals, such as described elsewhere herein. The curable fluid matrix material can be or comprise a cross-linkable material, a gellable material, an ultraviolet (UV) light/radiation curable material, a thermally curable material, a material that is enzymatically curable, a material that is chemically curable, combinations thereof, and/or the like.

The dispensing tip 94 can be dimensioned and configured to dispense, extrude, or otherwise communicate a mixture of the curable fluid matrix material and the one or more pest control chemicals therethrough. The mixture of the curable fluid matrix material and the one or more pest control chemicals can be formed before or during communication of the mixture of the curable fluid matrix material and the one or more pest control chemicals through the dispensing tip 94.

In some embodiments, the curable fluid matrix material can be initially stored in a first reservoir and the one or more pest control chemicals can be stored in one or more second reservoirs. Thereafter, a volume or a mass of the curable fluid matrix material can be communicated from the first reservoir to the dispensing tip 94 and a volume or a mass of the one or more pest control chemicals can be communicated from the one or more second reservoirs to the dispensing tip 94.

In some embodiments, the dispensing tip 94 can comprise a static mixer (not shown) that is configured to mix the volume/mass of the one or more pest control chemicals with the volume/mass of the curable fluid matrix material just prior to the communication of the mixture of the curable fluid matrix material and the one or more pest control chemicals through the dispensing tip 94.

In some embodiments, the dispensing tip 94 can be dimensioned and configured such that the communication of the mixture of the curable fluid matrix material and the one or more pest control chemicals through the dispensing tip 94 causing formation of a solid pest barrier, from the mixture of the curable fluid matrix material and the one or more pest control chemicals, according to a particular desired form factor. For example, the dispensing tip 94 can comprise or define an interior volume that is generally conical in shape and has a dispensing aperture defined in a narrowest end of the dispensing tip 94. For example, a shape (e.g., round, oval, etc.) of the dispensing aperture of the dispensing tip 94 may, at least in part, dictate the resulting shape of the solid pest barrier dispensed or extruded therefrom. Additionally or alternatively, an extrusion rate at which the mixture of the curable fluid matrix material and the one or more pest control chemicals is communicated through/extruded from the dispensing tip 94 may dictate, at least in part, the resulting shape of the solid pest barrier dispended or extruded therefrom.

In some embodiments, the dispensing tip 94 can comprise or be part of a self-contained tube containing therein a volume of the mixture of the curable fluid matrix material and the one or more pest control chemicals. In some embodiments, the solid pest barrier 92 can be formed by dispensing the mixture of the curable fluid matrix material and the one or more pest control chemicals from within the self-contained tube, through the dispensing tip 94, thereby forming the solid pest barrier 92. In some embodiments, the solid pest barrier 92 can be formed by dispensing the mixture of the curable fluid matrix material and the one or more pest control chemicals from within the self-contained tube, through the dispensing tip 94, and the dispensed mixture of the curable fluid matrix material and the one or more pest control chemicals can thereafter be at least partially cured, thereby forming the solid pest barrier 92.

In some embodiments, curing the mixture of the curable fluid matrix material and the one or more pest control chemicals to form the solid pest barrier 92 can be carried out using one or more curing means or cross-linking means, which may include one or more of: visible light, UV light, electromagnetic radiation, heat, water, an enzyme, a chemical, other suitable curing or cross-linking triggers, combinations thereof, and/or the like.

In some embodiments, the dispensing tip 94 can be used to form the solid pest barrier 92 by extruding or otherwise dispensing the mixture of the curable fluid matrix material and the one or more pest control chemicals onto or within a portion of a structure (e.g., 16). For example, the solid pest barrier 92 can be extruded directly onto an outer surface of a portion of a structure, such as onto an outside surface of the foundation of the structure, onto an outside surface of siding of the structure, and/or the like.

In some embodiments, the process 90 can comprise applying the solid pest barrier 92 onto or about a structure during initial construction of the structure. In some embodiments, the process 90 can comprise applying the solid pest barrier 92 onto or about a structure after the structure has been fully constructed and during use of the structure. In some embodiments, the solid pest barrier 92 can be disposed within a portion of the structure, such as under exterior siding of the structure, such that it is not possible for a human or non-pest organism on the outside of the structure to come directly into contact with the solid pest barrier 92. This may make it possible for a higher dosage or ratio of the pest control chemical(s) to be used relative to the curable fluid matrix material without directly increasing the risk of undesirable exposure to humans or other non-pest organisms located near the solid pest barrier 92.

Alternatively, in other embodiments, a solid pest barrier (e.g., 92) can be pre-made or pre-extruded. In some embodiments, the solid pest barrier can be cord-like, cable-like, rope-like, and/or the like. In some embodiments, the solid pest barrier can be flexible, rigid, elastic, plastic, or the like. In some embodiments, the solid pest barrier can be flexible initially (e.g., before curing or cross-linking) and thereafter less flexible or inflexible (e.g., after curing or cross-linking). In other embodiments, the solid pest barrier can be flexible over its entire lifespan.

In some embodiments, a pre-made or pre-extruded solid pest barrier can include an adhesive material disposed onto or jointed to at least one side or surface of the solid pest barrier. In some embodiments, the adhesive material can be jointed to, or disposed on, the solid pest barrier at the time of application or deployment of the solid pest barrier to the application area (e.g., 14). In other embodiments, the solid pest barrier can be pre-made or pre-extruded and already have the adhesive material disposed on, or joined to, the solid pest barrier, such that the person or device deploying the solid pest barrier does not have to dispose the adhesive material onto the solid pest barrier at the time of deployment of the solid pest barrier within the application area. In some embodiments, when the solid pest barrier comes with the adhesive material already disposed on or joined to the solid pest barrier, a covering or the like can be used to cover the adhesive material prior to deployment of the solid pest barrier within the application area. For example, a protective covering, e.g., a paper, a sheet, a ribbon, a strip, or the like, can be disposed over the adhesive material disposed on or jointed to the solid pest barrier. The protective covering can then be removed from about/over the adhesive material just prior to deployment of the solid pest barrier to within the application area.

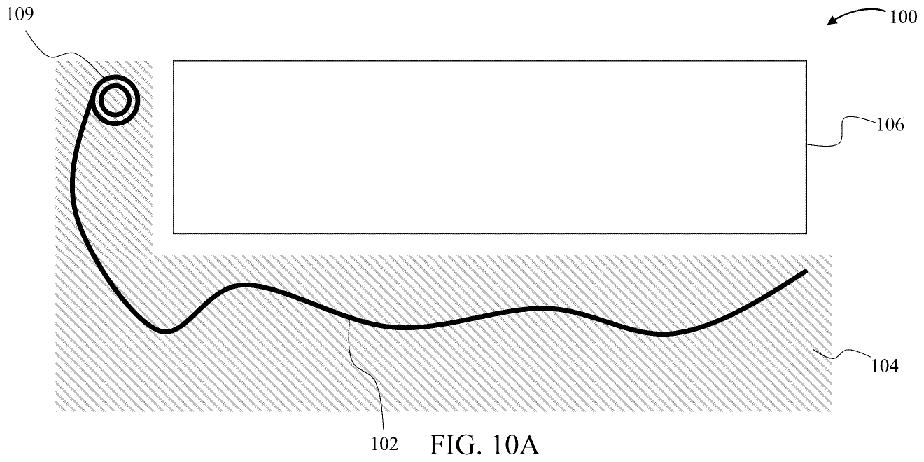

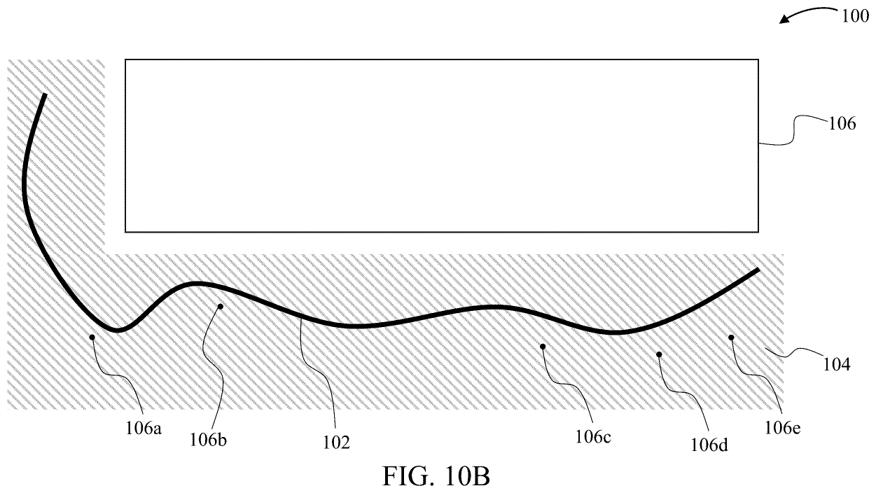

Referring now to FIGS. 10A and 10B, a process 100 for deployment of a solid pest barrier 102 within an application area 104 about a structure 106 is illustrated. The solid pest barrier 102 can be deployed from a roller 109 of the solid pest barrier 102 that is disposed about it. In embodiments in which a reservoir comprising a replenishing supply of the pest control chemical(s) is fluidically coupled to the solid pest barrier 102, the roller 109 can be configured to be in fluidic communication with both the solid pest barrier 102 and the reservoir (not shown).

As illustrated in FIG. 10B, after deployment of the solid pest barrier 102 within the application area 104 about the structure 106, the solid pest barrier 102 can deliver pest control chemical(s) to the application area 104 through the degradation of the solid pest barrier 102 itself, or portions thereof. For example, a plurality of pest barrier fragments 106a-106e can be released or fragmented from the solid pest barrier 102 and can be dispersed about the application area 104.

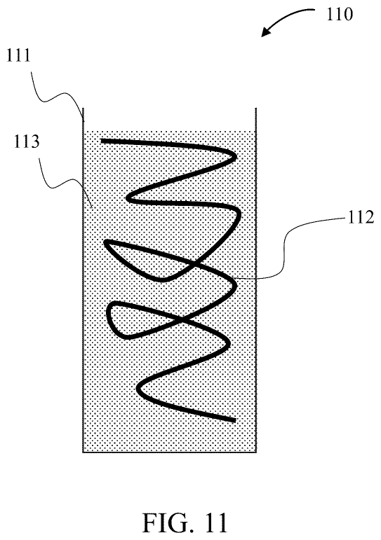

Referring now to FIG. 11, a replenishment process 110 is illustrated for replenishing or recharging a pest control chemical 113 in a solid pest barrier 112. The replenishment process 110 can be carried out to replenish the pest control chemical 113 on/in the solid pest barrier 112 after an initial or earlier deployment of the solid pest barrier 112 within the application area 104. The replenishment process 110 comprises disposing the solid pest barrier 112 into a replenishment vessel 111 filled with a replenishing supply of the pest control chemical 113. By submerging the solid pest barrier 112 into the replenishing supply of the pest control chemical 113 in the replenishment vessel 111, the capillary action caused by the dimensions of pores/capillaries within the solid pest barrier 112 can cause impregnation of the pest control chemical 113 into the pores/capillaries within the solid pest barrier 112.

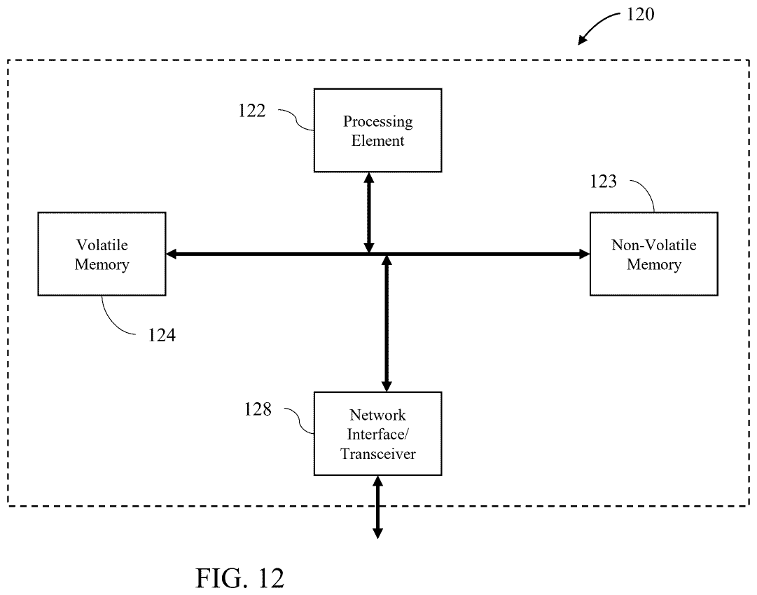

Processes for manufacturing a solid pest barrier (e.g., 12, 22, 32, 42, 52), or portions thereof, can be carried out by a computing device, such as computing device 120 illustrated in FIG. 12. As such, embodiments of the present invention may be implemented in various ways, including as computer program products that comprise articles of manufacture. Such computer program products may include one or more software components including, for example, software objects, methods, data structures, or the like.

As used herein, the terms “instructions,” “file,” “designs,” “data,” “content,” “information,” and similar terms may be used interchangeably, according to some example embodiments of the present invention, to refer to data capable of being transmitted, received, operated on, displayed, and/or stored. Thus, use of any such terms should not be taken to limit the spirit and scope of the disclosure. Further, where a computing device is described herein to receive data from another computing device, it will be appreciated that the data may be received directly from the other computing device or may be received indirectly via one or more computing devices, such as, for example, one or more servers, relays, routers, network access points, base stations, and/or the like.

As used herein, the term “computer-readable medium” refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, and infrared waves. Signals include man-made transient variations in amplitude, frequency, phase, polarization, or other physical properties transmitted through the transmission media. Examples of non-transitory computer-readable media include a floppy disk, a flexible disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

As used herein, the term “circuitry” refers to all of the following: (a) hardware-only circuit implementations (such as implementations in only analog and/or digital circuitry); (b) to combinations of circuits and computer program product(s) comprising software (and/or firmware instructions stored on one or more computer readable memories), such as (as applicable): (i) to a combination of processor(s) or (ii) to portions of processor(s)/software (including digital signal processor(s)), software, and memory(ies) that work together to cause an apparatus, such as a mobile phone or server, to perform various functions described herein); and (c) to circuits, such as, for example, a microprocessor(s) or a portion of a microprocessor(s), that require software or firmware for operation, even if the software or firmware is not physically present. This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, other network device, and/or other computing device.

As used herein, the term “computing device” refers to a specialized, centralized device, network, or system, comprising at least a processor and a memory device including computer program code, and configured to provide guidance or direction related to the formation, deployments, and/or recharging of solid pest barriers.

A software component may be coded in any of a variety of programming languages. An illustrative programming language may be a lower-level programming language, such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Example Computing Device

Referring to FIG. 12, illustrated therein is a schematic of a computing device 120 that can be configured to monitor and control a manufacturing system/device for manufacturing a solid pest barrier (e.g., 12, 22, 32, 42, 52, 62, 72, 82, 92). Alternatively, the computing device 120 can be configured to cause a device to mix a carrier material with pest control chemical(s) and/or extrude the mixture to form the solid pest barrier. The computing device 120 may comprise one or more processing elements 122, one or more non-volatile memories 123, one or more volatile memories 124, and/or one or more transmitter/receivers 128 (e.g., “transceivers 128”).

In some embodiments, the computing device 120 is configured to store one or more computer program products, computer program code, a computer-readable media comprising instructions, and/or the like. In some embodiments, the computing device 120 is configured to determine or receive information regarding at least a portion of a solid pest barrier manufacturing process, such process configurations, material characteristics, manufacturing metrics, and/or other information regarding a current status of the system.

In some embodiments, the computing device 120 is configured to carry out at least a part of one of the processes/methods described herein (e.g., 130, 140, 150, 160, 170) in the full or partial manufacture or formation of a solid pest barrier (e.g., 12, 22, 32, 42, 52, 62, 72, 82, 92). Information can be received by the computing device 120 from a manual input, one or more sensors, and/or the like. In some embodiments, the computing device 120 is configured, using any suitable means, to be in wired or wireless communication, such as via the transceivers 128, with one or more motors, conveyors, valves, actuators, pumps, sensors, and/or the like (not shown). The computing device 120 can be configured to directly control equipment such as a mixer, an extruder, an injection molding system, a reservoir control system, or devices for controlling the same (e.g., to carry out all or part of the manufacturing process). In some embodiments, the computing device 120 can be configured to communicate a set of instructions to one or more motors, actuators, sensors, valves, pumps, and/or the like, for one or a series of actions to be carried out. For example, the computing device 120 can provide flow rate instructions, e.g., in conjunction with other instructions, to one or more of motors, actuators, sensors, valves, pumps, and/or the like in order for the proper flow rate or discrete volume of polymeric material or cross-linkable material or the like, and/or pest control chemical(s) to be communicated to a mixer, extruder, injection molding system, or the like.

In some embodiments, the computing device 120 can be configured to cause one or more devices to perform a method of manufacturing a solid pest barrier (e.g., 12, 22, 32, 42, 52, 62, 72, 82, 92). This can be based upon computer-readable instructions or computer code stored in one or more memories of the computing device 120 that are executable by one or more processors of the computing device 120. For example, the computing device 120 can cause one or more pumps or conveyors or the like to communicate material into a mixing container or the like. The computing device 120 can be configured to control the pumps, conveyors, or the like, such as by sending commands, instructions, electrical signals, or the like directly to the pump, conveyor, or the like, and/or by sending commands, instructions, electrical signals, or the like to a controller or processor that controls the pump, conveyor, or the like.

The computing device 120 can cause one or more mixing devices to mix or otherwise combine materials to form the solid pest barrier or a portion thereof. The computing device 120 can be configured to control the mixing device(s) by sending commands, instructions, electrical signals, or the like directly to the mixing device(s) and/or by sending commands, instructions, electrical signals, or the like to a controller or processor that controls the mixing device(s).

The computing device 120 can be configured to control one or more pumps, nozzles, robotic arms, actuators, valves, meters, and/or the like to dispose pest control chemical(s) onto or within at least a portion of a solid pest barrier (e.g., 12, 22, 32, 42, 52, 62, 72, 82, 92), such as by sending commands, instructions, electrical signals, or the like directly to the pumps, nozzles, robotic arms, actuators, valves, meters, and/or the like, and/or by sending commands, instructions, electrical signals, or the like to a controller or processor that controls the pumps, nozzles, robotic arms, actuators, valves, meters, and/or the like.

The computing device 120 can be configured to control one or more dryers, robotic arms, conveyors, motors, pumps, screens, meters, and/or the like to at least partially dry a material, such as to achieve an average pore or microchannel dimension to facilitate sufficient capillarity to retain pest control chemical(s) within the solid pest barrier (e.g., 12, 22, 32, 42, 52, 62, 72, 82, 92), such as by sending commands, instructions, electrical signals, or the like directly to a dryer, robotic arms, conveyors, motors, pumps, screens, meters, and/or the like, and/or by sending commands, instructions, electrical signals, or the like to a controller or processor that controls the dryers, robotic arms, conveyors, motors, pumps, screens, meters, and/or the like.

The computing device 120 can be configured to control one or more pumps, motors, robotic arms, conveyors, meters, and/or the like to dispense the solid pest barrier within an application area (e.g., 14) about a structure (e.g., 16), such as by sending commands, instructions, electrical signals, or the like directly to the pumps, motors, robotic arms, conveyors, meters, and/or the like, and/or by sending commands, instructions, electrical signals, or the like to a controller or processor that controls the pumps, motors, robotic arms, conveyors, meters, and/or the like.

The computing device 120 can be configured to control one or more motors, rollers, conveyors, robotic arms, valves, air compressors, nozzles, reservoirs, pumps, meters, sensors, and/or the like to impregnate the solid pest barrier with pest control chemical(s). The computing device 120 can be configured to carry this out by sending commands, instructions, electrical signals, or the like directly to the motors, rollers, conveyors, robotic arms, valves, air compressors, nozzles, pumps, meters, sensors, and/or the like, and/or by sending commands, instructions, electrical signals, or the like to a controller or processor that controls the motors, rollers, conveyors, robotic arms, valves, air compressors, nozzles, pumps, meters, sensors, and/or the like.

In general, the terms computing device, computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As shown in FIG. 12, in some embodiments, the computing device 120 may include or be in communication with one or more processing elements 122 (also referred to as processors, processing circuitry, and/or similar terms used herein interchangeably) that communicate with other elements within the computing device 120 via a bus, for example. As will be understood, the processing element 122 may be embodied in a number of different ways. For example, the processing element 122 may be embodied as one or more complex programmable logic devices (CPLDs), microprocessors, multi-core processors, coprocessing entities, application-specific instruction-set processors (ASIPs), microcontrollers, and/or controllers. Further, the processing element 122 may be embodied as one or more other processing devices or circuitry. The term circuitry may refer to an entirely hardware embodiment or a combination of hardware and computer program products. Thus, the processing element 122 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 122 may be configured for a particular use or configured to execute instructions stored in volatile or non-volatile media or otherwise accessible to the processing element 122. As such, whether configured by hardware or computer program products, or by a combination thereof, the processing element 122 may be capable of performing steps or operations according to embodiments of the present invention when configured accordingly.

In one embodiment, the computing device 120 may further include or be in communication with non-volatile media (also referred to as non-volatile storage, memory, memory storage, memory circuitry, and/or similar terms used herein interchangeably). In one embodiment, the non-volatile storage or memory may include the one or more non-volatile memories 123, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing device 120 may further include or be in communication with volatile media (also referred to as volatile storage, memory, memory storage, memory circuitry, and/or similar terms used herein interchangeably). In one embodiment, the volatile storage or memory may also include one or more volatile memories 124, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 122. Thus, the databases, database instances, database management systems, data, applications, programs, program modules, scripts, source code, object code, byte code, compiled code, interpreted code, machine code, executable instructions, and/or the like may be used to control certain aspects of the operation of the computing device 120 with the assistance of the processing element 122 and operating system.

In some embodiments, the computing device 120 may also include one or more network interfaces, such as a transceiver 128 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing device 120 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing device 120 may include or be in communication with one or more input elements, such as a keyboard input, a mouse input, a touch screen/display input, motion input, movement input, audio input, pointing device input, joystick input, keypad input, and/or the like. The computing device 120 may also include or be in communication with one or more output elements (not shown), such as audio output, video output, screen/display output, motion output, movement output, and/or the like.

Nevertheless, the computing device 120 can be configured to control elements of a system or device, such as that used in other processes and methods described herein. The computing device 120 can be in operable communication with one or more sensors, one or more valves, one or more actuators, one or more conveyers, one or more motors, one or more pumps, one or more scales, one or more imaging devices, one or more radiation (e.g., infrared radiation [IR], near-IR) emission devices, one or more moisture content monitors, one or more rollers, one or more robotic arms, one or more presses, one or more extruders, one or more injection molding devices, one or more cameras, one or more emissions sensors, one or more dryers (e.g., in-line dryers), one or more reservoirs, one or more nozzles, one or more mixers, and/or the like.

In some embodiments, the computing device 120 can be configured to carry out most or all of a process of manufacturing a solid pest barrier (e.g., 12, 22, 32, 42, 52, 62, 72, 82, 92). Alternatively, in some embodiments, the computing device 120 can be configured to carry out only a portion of the process of manufacturing a solid pest barrier.

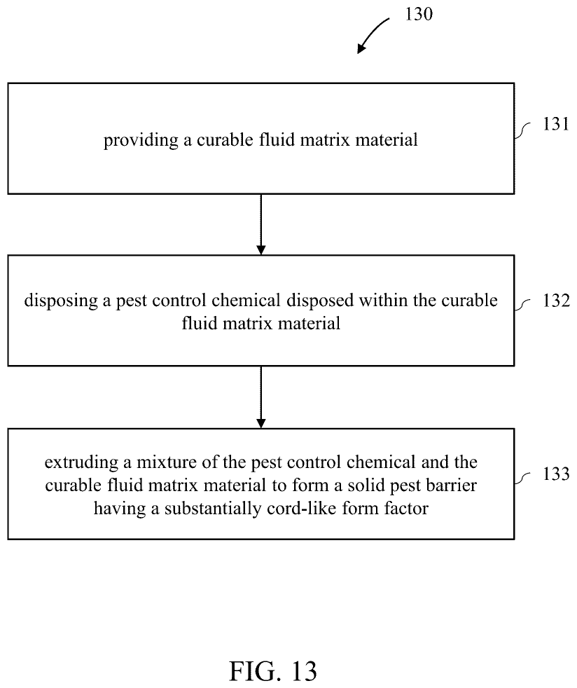

FIG. 13 illustrates a method 130 for manufacturing a solid pest barrier. The method 130 can comprise providing a curable fluid matrix material, at 131. The method 130 can further comprise disposing a pest control chemical disposed within the curable fluid matrix material, at 132. The method 130 can further comprise extruding a mixture of the pest control chemical and the curable fluid matrix material to form a solid pest barrier having a substantially cord-like form factor, at 133.

Some or all of the elements of the method 130 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 130 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 130, whether in part or in full.

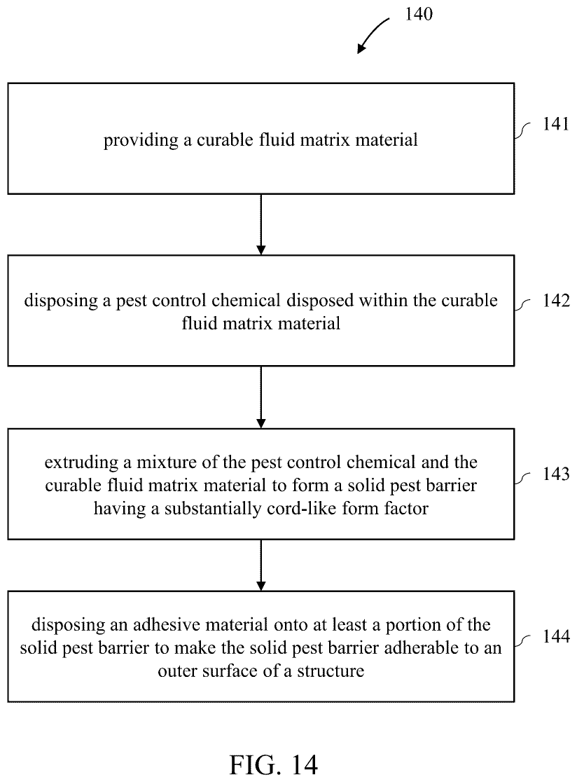

FIG. 14 illustrates a method 140 for manufacturing a solid pest barrier. The method 140 can comprise providing a curable fluid matrix material, at 141. The method 140 can further comprise disposing a pest control chemical disposed within the curable fluid matrix material, at 142. The method 140 can further comprise extruding a mixture of the pest control chemical and the curable fluid matrix material to form a solid pest barrier having a substantially cord-like form factor, at 143. The method 140 can further comprise disposing an adhesive material onto at least a portion of the solid pest barrier to make the solid pest barrier adherable to an outer surface of a structure, at 144.

Some or all of the elements of the method 140 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 140 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 140, whether in part or in full.

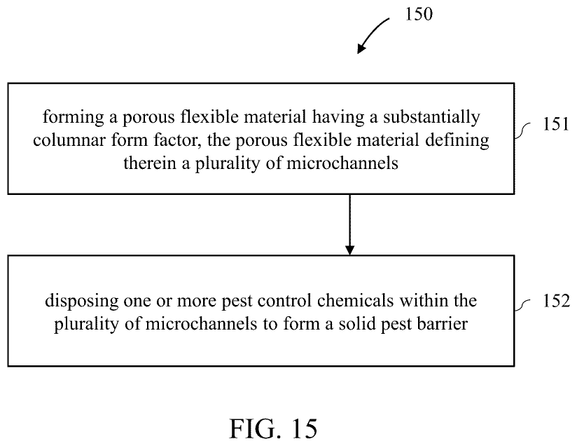

FIG. 15 illustrates a method 150 for manufacturing a solid pest barrier. The method 150 can comprise forming a porous flexible material having a substantially columnar form factor, the porous flexible material defining therein a plurality of microchannels, at 151. The method 150 can further comprise disposing one or more pest control chemicals within the plurality of microchannels to form a solid pest barrier, at 152.

Some or all of the elements of the method 150 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a furnace, a mixer, an extruder, an injection molding device, a press, rollers, and/or the like. By causing and controlling operation of another component or element, the computing device 120 can cause one or more elements of the method 150 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 150, whether in part or in full.

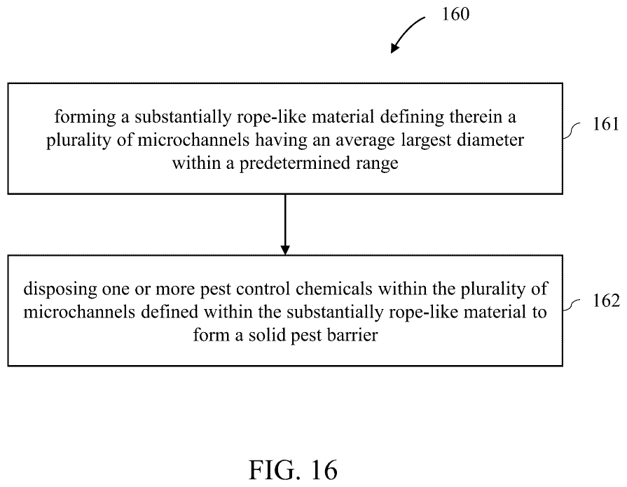

FIG. 16 illustrates a method 160 for manufacturing a solid pest barrier. The method 160 can comprise forming a substantially cord-like or rope-like material defining therein a plurality of microchannels having an average largest diameter within a predetermined range, at 161. The method 160 can further comprise disposing one or more pest control chemicals within the plurality of microchannels defined within the substantially cord-like or rope-like material to form a solid pest barrier, at 162.

Some or all of the elements of the method 160 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 160 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 160, whether in part or in full.

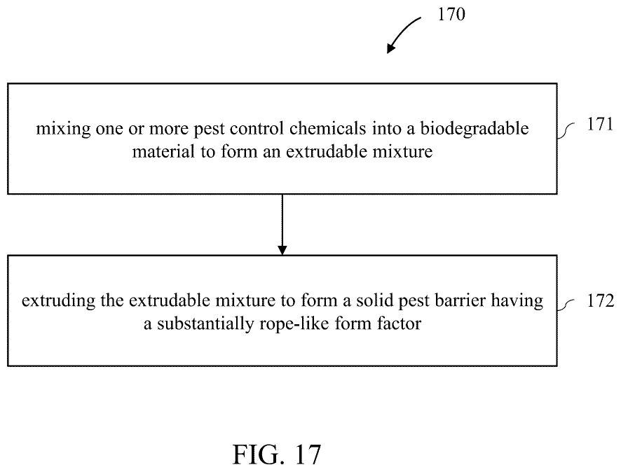

FIG. 17 illustrates a method 170 for manufacturing a solid pest barrier. The method 170 can comprise mixing one or more pest control chemicals into a biodegradable material to form an extrudable mixture, at 171. The method 170 can further comprise extruding the extrudable mixture to form a solid pest barrier having a substantially cord-like or rope-like form factor, at 172.

Some or all of the elements of the method 170 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a reservoir a press, rollers, and/or the like. By causing and controlling operation of another component or element, the computing device 120 can cause one or more elements of the method 170 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 170, whether in part or in full.

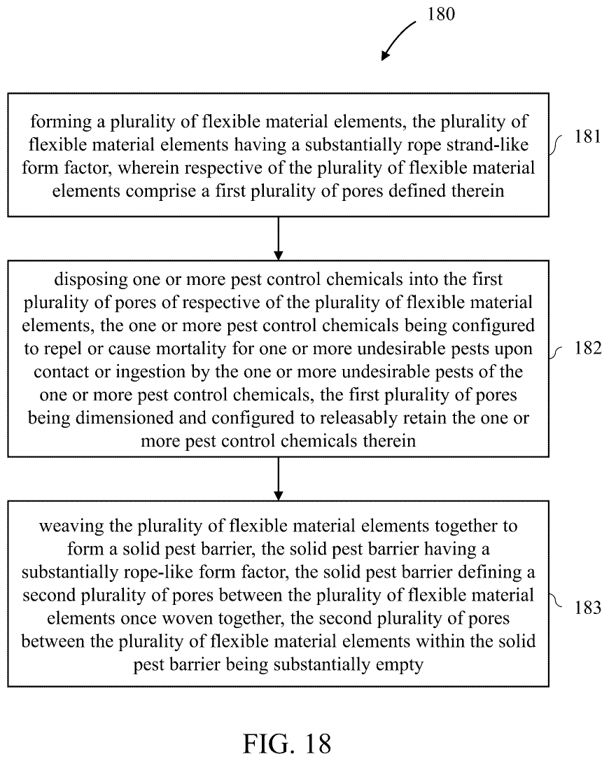

FIG. 18 illustrates a method 180 for manufacturing a solid pest barrier. The method 180 can comprise forming a plurality of flexible material elements, the plurality of flexible material elements having a substantially rope strand-like form factor, wherein respective of the plurality of flexible material elements comprise a first plurality of pores defined therein, at 181. The method 180 can further comprise disposing one or more pest control chemicals into the first plurality of pores of respective of the plurality of flexible material elements, the one or more pest control chemicals being configured to repel or cause mortality for one or more undesirable pests upon contact or ingestion by the one or more undesirable pests of the one or more pest control chemicals, the first plurality of pores being dimensioned and configured to releasably retain the one or more pest control chemicals therein, at 182. The method 180 can further comprise weaving the plurality of flexible material elements together to form a solid pest barrier, the solid pest barrier having a substantially cord-like or rope-like form factor, the solid pest barrier defining a second plurality of pores between the plurality of flexible material elements once woven together, the second plurality of pores between the plurality of flexible material elements within the solid pest barrier being substantially empty, at 183.

Some or all of the elements of the method 180 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, an extruder, an injection molding device, a press, rollers, and/or the like. By causing and controlling operation of another component or element, the computing device 120 can cause one or more elements of the method 180 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 180, whether in part or in full.

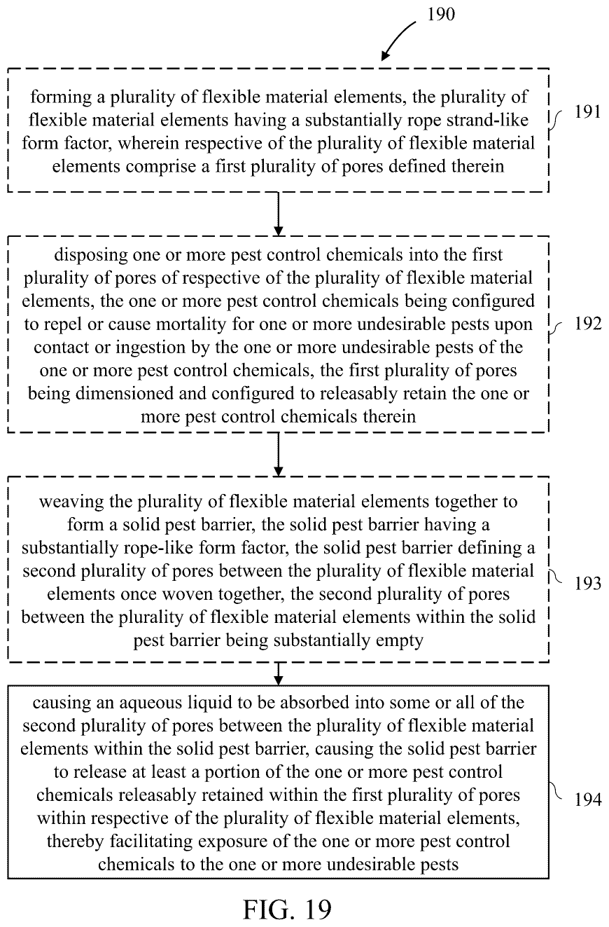

FIG. 19 illustrates a method 190 for manufacturing a solid pest barrier. The method 190 can comprise forming a plurality of flexible material elements, the plurality of flexible material elements having a substantially rope strand-like form factor, wherein respective of the plurality of flexible material elements comprise a first plurality of pores defined therein, at 191. The method 190 can further comprise disposing one or more pest control chemicals into the first plurality of pores of respective of the plurality of flexible material elements, the one or more pest control chemicals being configured to repel or cause mortality for one or more undesirable pests upon contact or ingestion by the one or more undesirable pests of the one or more pest control chemicals, the first plurality of pores being dimensioned and configured to releasably retain the one or more pest control chemicals therein, at 192. The method 190 can further comprise weaving the plurality of flexible material elements together to form a solid pest barrier, the solid pest barrier having a substantially cord-like or rope-like form factor, the solid pest barrier defining a second plurality of pores between the plurality of flexible material elements once woven together, the second plurality of pores between the plurality of flexible material elements within the solid pest barrier being substantially empty, at 193. The method 190 can further comprise causing an aqueous liquid to be absorbed into some or all of the second plurality of pores between the plurality of flexible material elements within the solid pest barrier, causing the solid pest barrier to release at least a portion of the one or more pest control chemicals releasably retained within the first plurality of pores within respective of the plurality of flexible material elements, thereby facilitating exposure of the one or more pest control chemicals to the one or more undesirable pests, at 194.

Some or all of the elements of the method 190 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 190 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 190, whether in part or in full.

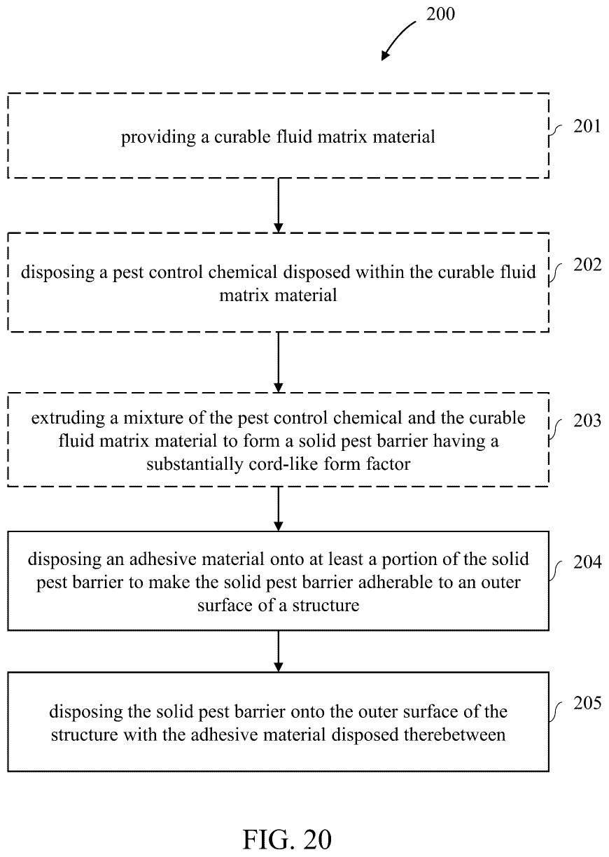

FIG. 20 illustrates a method 200 for manufacturing a solid pest barrier. The method 200 can, optionally, comprise providing a curable fluid matrix material, at 201. The method 200 can, optionally, further comprise disposing a pest control chemical disposed within the curable fluid matrix material, at 202. The method 200 can, optionally, further comprise extruding a mixture of the pest control chemical and the curable fluid matrix material to form a solid pest barrier having a substantially cord-like form factor, at 203. The method 200 can further comprise disposing an adhesive material onto at least a portion of the solid pest barrier to make the solid pest barrier adherable to an outer surface of a structure, at 204. The method 200 can further comprise disposing the solid pest barrier onto the outer surface of the structure with the adhesive material disposed therebetween, at 205.

Some or all of the elements of the method 200 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 200 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 200, whether in part or in full.

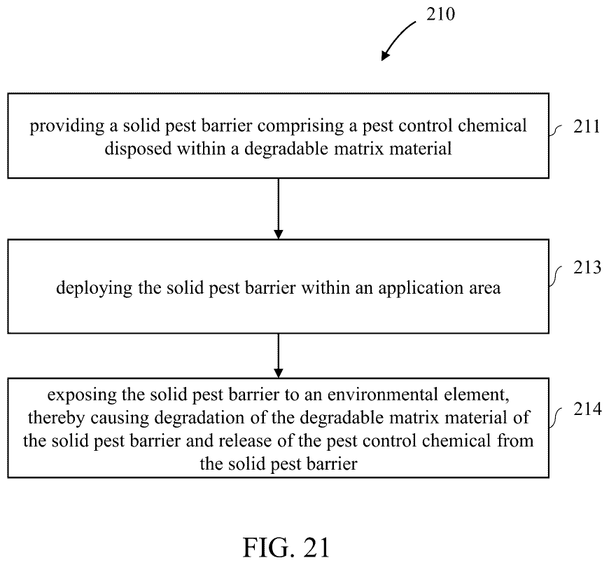

FIG. 21 illustrates a method 210 for deploying a solid pest barrier. The method 210 can comprise providing a solid pest barrier comprising a pest control chemical disposed within a degradable matrix material, at 211. The method 210 can further comprise deploying the solid pest barrier within an application area, at 212. The method 210 can further comprise exposing the solid pest barrier to an environmental element, thereby causing degradation of the degradable matrix material of the solid pest barrier and release of the pest control chemical from the solid pest barrier, at 213.

Some or all of the elements of the method 210 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 210 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 210, whether in part or in full.

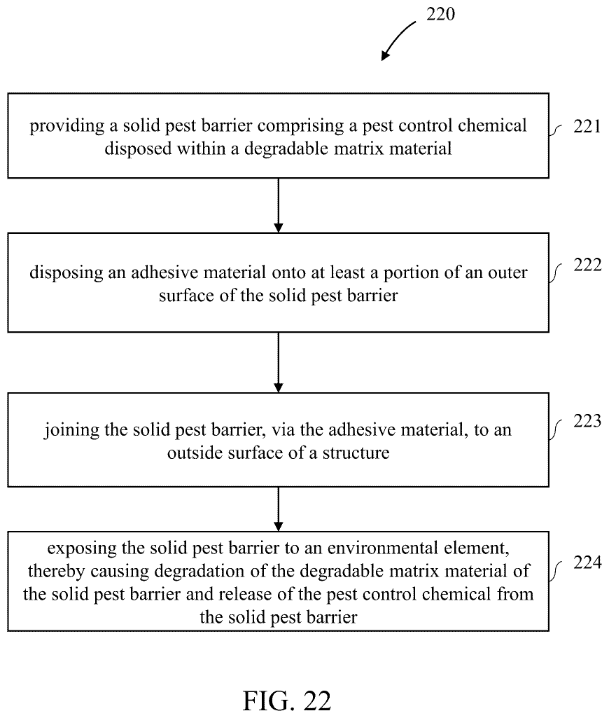

FIG. 22 illustrates a method 220 for deploying a solid pest barrier. The method 220 can comprise providing a solid pest barrier comprising a pest control chemical disposed within a degradable matrix material, at 221. The method 220 can further comprise disposing an adhesive material onto at least a portion of an outer surface of the solid pest barrier, at 222. The method 220 can further comprise joining the solid pest barrier, via the adhesive material, to an outside surface of a structure, at 223. The method 220 can further comprise exposing the solid pest barrier to an environmental element, thereby causing degradation of the degradable matrix material of the solid pest barrier and release of the pest control chemical from the solid pest barrier, at 224.

Some or all of the elements of the method 220 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 220 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 220, whether in part or in full.

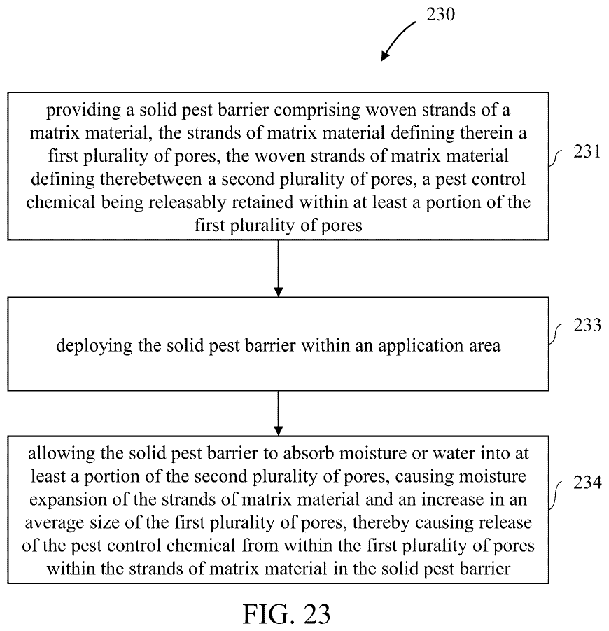

FIG. 23 illustrates a method 230 for deploying a solid pest barrier. The method 230 can comprise providing a solid pest barrier comprising woven strands of a matrix material, the strands of matrix material defining therein a first plurality of pores, the woven strands of matrix material defining therebetween a second plurality of pores, a pest control chemical being releasably retained within at least a portion of the first plurality of pores, at 231. The method 230 can further comprise deploying the solid pest barrier within an application area, at 232. The method 230 can further comprise allowing the solid pest barrier to absorb moisture or water into at least a portion of the second plurality of pores, causing moisture expansion of the strands of matrix material and an increase in an average size of the first plurality of pores, thereby causing release of the pest control chemical from within the first plurality of pores within the strands of matrix material in the solid pest barrier, at 233.

Some or all of the elements of the method 230 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 230 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 230, whether in part or in full.

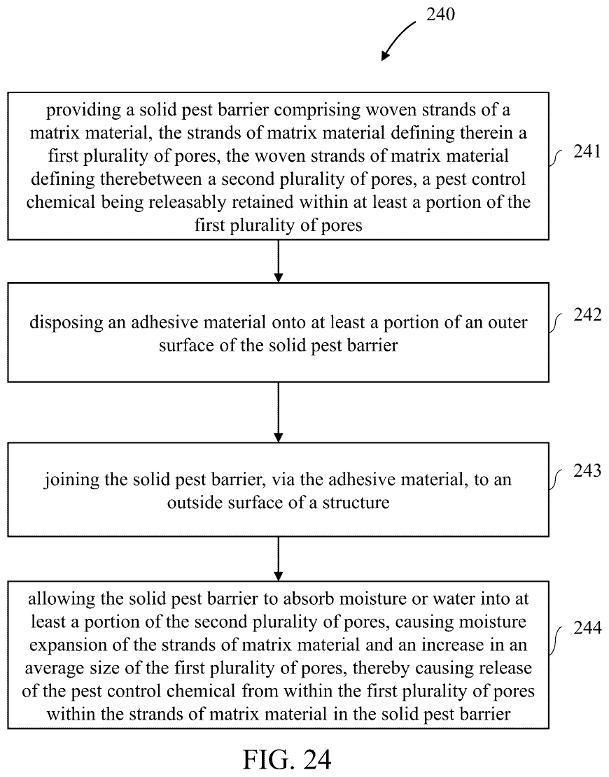

FIG. 24 illustrates a method 240 for deploying a solid pest barrier. The method 240 can comprise providing a solid pest barrier comprising woven strands of a matrix material, the strands of matrix material defining therein a first plurality of pores, the woven strands of matrix material defining therebetween a second plurality of pores, a pest control chemical being releasably retained within at least a portion of the first plurality of pores, at 241. The method 240 can further comprise disposing an adhesive material onto at least a portion of an outer surface of the solid pest barrier, at 242. The method 240 can further comprise joining the solid pest barrier, via the adhesive material, to an outside surface of a structure, at 243. The method 240 can further comprise allowing the solid pest barrier to absorb moisture or water into at least a portion of the second plurality of pores, causing moisture expansion of the strands of matrix material and an increase in an average size of the first plurality of pores, thereby causing release of the pest control chemical from within the first plurality of pores within the strands of matrix material in the solid pest barrier, at 244.

Some or all of the elements of the method 240 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 240 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 240, whether in part or in full.

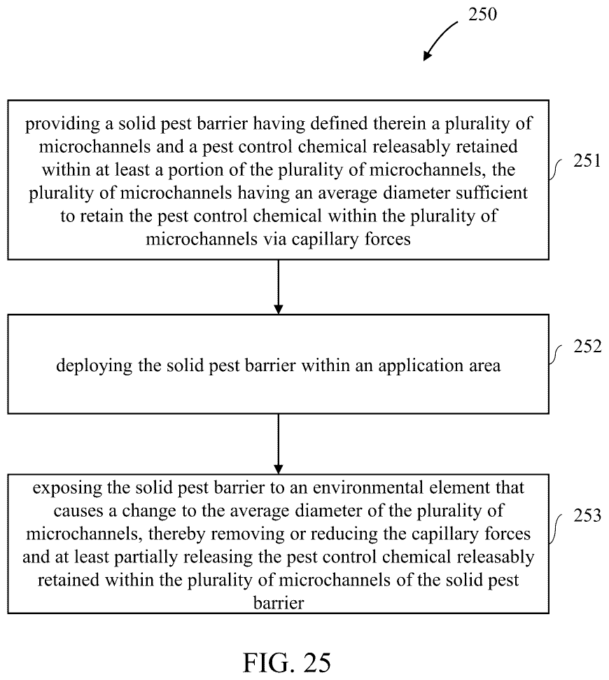

FIG. 25 illustrates a method 250 for deploying a solid pest barrier. The method 250 can comprise providing a solid pest barrier having defined therein a plurality of microchannels and a pest control chemical releasably retained within at least a portion of the plurality of microchannels, the plurality of microchannels having an average diameter sufficient to retain the pest control chemical within the plurality of microchannels via capillary forces, at 251. The method 250 can further comprise providing a solid pest barrier having defined therein a plurality of microchannels and a pest control chemical releasably retained within at least a portion of the plurality of microchannels, the plurality of microchannels having an average diameter sufficient to retain the pest control chemical within the plurality of microchannels via capillary forces, at 252. The method 250 can further comprise exposing the solid pest barrier to an environmental element that causes a change to the average diameter of the plurality of microchannels, thereby removing or reducing the capillary forces and at least partially releasing the pest control chemical releasably retained within the plurality of microchannels of the solid pest barrier, at 253.

Some or all of the elements of the method 250 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 250 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 250, whether in part or in full.

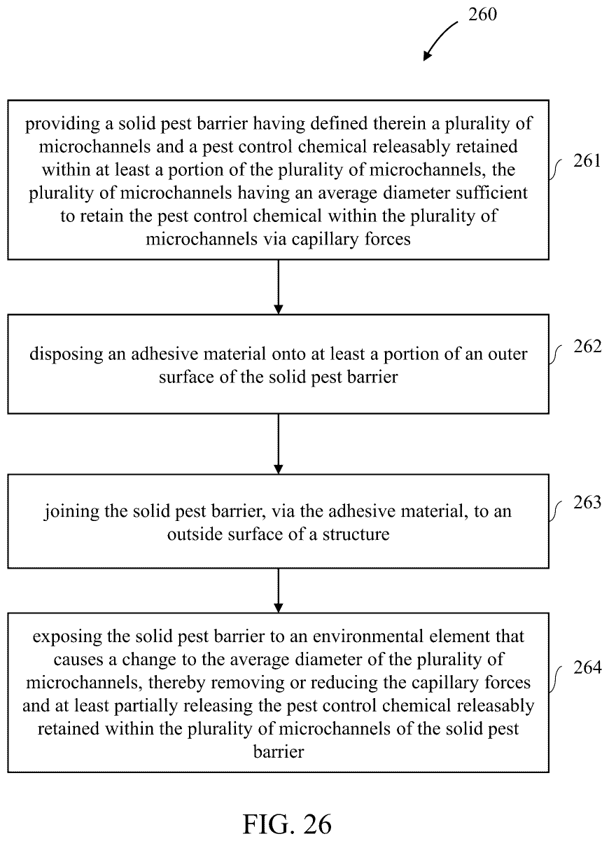

FIG. 26 illustrates a method 260 for deploying a solid pest barrier. The method 260 can comprise providing a solid pest barrier having defined therein a plurality of microchannels and a pest control chemical releasably retained within at least a portion of the plurality of microchannels, the plurality of microchannels having an average diameter sufficient to retain the pest control chemical within the plurality of microchannels via capillary forces, at 261. The method 260 can further comprise disposing an adhesive material onto at least a portion of an outer surface of the solid pest barrier, at 262. The method 260 can further comprise joining the solid pest barrier, via the adhesive material, to an outside surface of a structure, at 263. The method 260 can further comprise exposing the solid pest barrier to an environmental element that causes a change to the average diameter of the plurality of microchannels, thereby removing or reducing the capillary forces and at least partially releasing the pest control chemical releasably retained within the plurality of microchannels of the solid pest barrier, at 264.

Some or all of the elements of the method 260 can be carried out by or controlled by a computing device, such as computing device 120. For example, the processing element 122 of the computing device 120 can, based upon instructions/program code stored in the volatile memory 124 and/or the non-volatile memory 123, cause and control operation of another component or element of a system/device, such as a robotic arm, a conveyor belt, a dryer, a mixer, an extruder, an injection molding device, a press, rollers, and/or the like. By causing and controlling operation of another component or element, the computing device 120 can cause one or more elements of the method 260 to be carried out in part or in full. In some embodiments, the computing device 120 can comprise the other component or element for which the processing element 122 is causing and controlling operation thereof. In other embodiments, the computing device 120 can be configured to communicate with another apparatus, device, system, or the like, to cause control of the other component or element in accordance with one or more elements of the method 260, whether in part or in full.

Some embodiments are disclosed herein for forming, deploying, using, recharging, and/or manufacturing solid pest barriers.

According to some embodiments, a composition of matter can be prepared or provided that comprises: a curable fluid matrix material; and a pest control chemical disposed within the curable fluid matrix material. In some embodiments, a mixture of the pest control chemical and the curable fluid matrix material is extrudable as a solid pest barrier having a cord-like form factor. In some embodiments, the curable matrix material is configured to at least partially solidify in response to exposure of the mixture of the pest control chemical and the curable matrix material to a curing trigger, thereby retaining the pest control chemical within the solid pest barrier. In some embodiments, during a treatment period following extrusion of the mixture of the pest control chemical and the curable fluid matrix material as the solid pest barrier, the pest control chemical is configured to repel or cause mortality for one or more undesirable pests upon contact or ingestion by the one or more undesirable pests of the pest control chemical from the solid pest barrier.

In some embodiments, the composition of matter can be configured to be joined to, or can further comprise, an adhesive material. For example, the adhesive material can be disposed to at least a portion of an outside of the solid pest barrier.

According to another embodiment, a solid pest barrier can be provided that comprises: a flexible woven material having a substantially cord-like form factor. In some embodiments, the flexible woven material comprises a plurality of flexible material elements that are woven together. In some embodiments, the plurality of flexible material elements having a substantially rope strand-like form factor. In some embodiments, a respective flexible material element of the plurality of flexible material elements comprises a first plurality of pores within the flexible material element. In some embodiments, the flexible woven material defines a second plurality of pores between the plurality of flexible material elements woven together to form the flexible woven material. In some embodiments, the first plurality of pores within respective of the plurality of flexible material elements are dimensioned and configured to releasably retain one or more pest control chemicals within the first plurality of pores. In some embodiments, the one or more pest control chemicals are configured to repel or cause mortality for one or more undesirable pests upon contact or ingestion by the one or more undesirable pests of the one or more pest control chemicals. In some embodiments, the second plurality of pores between the plurality of flexible material elements within the flexible woven material are substantially empty prior to deployment of the solid pest barrier. In some embodiments, in an instance in which an aqueous liquid is absorbed into some or all of the second plurality of pores between the plurality of flexible material elements within the flexible woven material, at least a portion of the one or more pest control chemicals releasably retained within the first plurality of pores within respective of the plurality of flexible material elements are released from the solid pest barrier, thereby facilitating exposure of the one or more pest control chemicals to the one or more undesirable pests.

In some embodiments, the flexible woven material has a first coefficient of moisture expansion within a first predetermined range. In some embodiments, respective of the flexible material elements have a second coefficient of moisture expansion within a second predetermined range. In some embodiments, the second plurality of pores defined within respective of the plurality of flexible material elements are dimensioned and configured to releasably retain the one or more pest control chemicals within the second plurality of pores using capillary action.

According to other embodiments, a solid pest barrier can be provided that comprises: a porous flexible material having a substantially columnar form factor. In some embodiments, the porous flexible material defines therein a plurality of microchannels. In some embodiments, the solid pest barrier can further comprise: one or more pest control chemicals disposed within the plurality of microchannels. In some embodiments, the porous flexible material has a coefficient of moisture expansion within a predetermined range such that the plurality of microchannels have a first average diameter within a first average diameter range when the porous flexible material is in a substantially dry configuration and the plurality of microchannels have a second average diameter within a second average diameter range when the porous flexible material is in a wetted configuration. In some embodiments, the second average diameter range being larger than the first average diameter range. In some embodiments, when the porous flexible material is in the substantially dry configuration and have the first average diameter, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, when the porous flexible material is in the wetted configuration and the plurality of microchannels have the second average diameter, the plurality of microchannels are dimensioned and configured to release some or all of the one or more pest control chemicals previously retained within the plurality of microchannels, causing release of at least a portion of the one or more pest control chemicals from the solid pest barrier, thereby facilitating exposure of the one or more pest control chemicals to the one or more undesirable pests.

According to some embodiments, a solid pest barrier can be provided that comprises: a porous flexible material having a substantially columnar form factor, the porous flexible material defining therein a plurality of microchannels having an average largest diameter within a predetermined range; and one or more pest control chemicals disposed within the plurality of microchannels defined within the porous flexible material. In some embodiments, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, the porous flexible material is configured to become increasingly friable during a desired pest control period following deployment of the solid pest barrier within an application area. In some embodiments, during the desired pest control duration following deployment of the solid pest barrier within the application area, as the porous flexible material becomes increasingly friable, the plurality of microchannels are dimensioned and configured to release some or all of the one or more pest control chemicals previously retained within the plurality of microchannels, causing release of at least a portion of the one or more pest control chemicals from the solid pest barrier, thereby facilitating exposure of the one or more pest control chemicals to the one or more undesirable pests.

In some embodiments, the porous flexible material is configured to become increasingly friable in response to exposure to one or more environmental elements. In some embodiments, the one or more environmental elements comprise at least one of: sunlight, irrigation water, rain, humidity, wind, heat, cold, or combinations thereof.

According to another embodiment, a solid pest barrier can be provided that comprises: a biodegradable material having a substantially cord-like form factor; and one or more pest control chemicals disposed within the biodegradable material. In some embodiments, the one or more pest control chemicals are configured to repel or cause mortality for one or more undesirable pests upon contact or ingestion by the one or more undesirable pests of the one or more pest control chemicals. In some embodiments, the biodegradable material is configured to biodegrade during a desired pest control period following deployment of the solid pest barrier within an application area. In some embodiments, during the desired pest control duration following deployment of the solid pest barrier within the application area, as the biodegradable material biodegrades, some or all of the one or more pest control chemicals disposed within the biodegradable material is released from the solid pest barrier, thereby facilitating exposure of the one or more pest control chemicals to the one or more undesirable pests.

In some embodiments, the biodegradable material is configured to at biodegrade in response to exposure to one or more environmental elements. In some embodiments, the one or more environmental elements comprise at least one of: sunlight, irrigation water, rain, humidity, wind, heat, cold, or combinations thereof. In some embodiments, the biodegradable material is configured to biodegrade at a rate that is sufficient such that the biodegradable material fully biodegrades at an end of the desired pest control duration following deployment of the solid pest barrier within the application area. In some embodiments, the decomposable material comprises polyglycolic acid, polylactic acid, polycaprolactone (PCL), and poly(lactide-co-glycolide) (PLGA), or combinations thereof.

According to other embodiments, a method can be carried out that comprises: forming a plurality of flexible material elements, the plurality of flexible material elements having a substantially rope strand-like form factor. In some embodiments, respective of the plurality of flexible material elements comprise a first plurality of pores defined therein. In some embodiments, the method can further comprise: disposing one or more pest control chemicals into the first plurality of pores of respective of the plurality of flexible material elements. In some embodiments, the one or more pest control chemicals being configured to repel or cause mortality for one or more undesirable pests upon contact or ingestion by the one or more undesirable pests of the one or more pest control chemicals. In some embodiments, the first plurality of pores are dimensioned and configured to releasably retain the one or more pest control chemicals therein. In some embodiments, the method can further comprise: weaving the plurality of flexible material elements together to form a solid pest barrier. In some embodiments, the solid pest barrier has a substantially cord-like form factor. In some embodiments, the solid pest barrier can define a second plurality of pores between the plurality of flexible material elements once woven together. In some embodiments, the second plurality of pores between the plurality of flexible material elements within the solid pest barrier are substantially empty. In some embodiments, in an instance in which an aqueous liquid is absorbed into some or all of the second plurality of pores between the plurality of flexible material elements within the solid pest barrier, the solid pest barrier is configured to release at least a portion of the one or more pest control chemicals releasably retained within the first plurality of pores within respective of the plurality of flexible material elements, thereby facilitating exposure of the one or more pest control chemicals to the one or more undesirable pests.

In some embodiments, the solid pest barrier has a first coefficient of moisture expansion within a first predetermined range. In some embodiments, respective of the flexible material elements have a second coefficient of moisture expansion within a second predetermined range. In some embodiments, the second plurality of pores defined within respective of the plurality of flexible material elements are dimensioned and configured to releasably retain the one or more pest control chemicals within the second plurality of pores using capillary action.

According to some embodiments, a method can be carried out that comprises: forming a porous flexible material having a substantially columnar form factor. In some embodiments, the porous flexible material can define therein a plurality of microchannels. In some embodiments, the method can further comprise: disposing one or more pest control chemicals within the plurality of microchannels to form a solid pest barrier. In some embodiments, the porous flexible material has a coefficient of moisture expansion within a predetermined range such that the plurality of microchannels have a first average diameter within a first average diameter range when the porous flexible material is in a substantially dry configuration and the plurality of microchannels have a second average diameter within a second average diameter range when the porous flexible material is in a wetted configuration. In some embodiments, the second average diameter range is larger than the first average diameter range. In some embodiments, when the porous flexible material is in the substantially dry configuration and has the first average diameter, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, when the porous flexible material is in the wetted configuration and the plurality of microchannels have the second average diameter, the plurality of microchannels are dimensioned and configured to release some or all of the one or more pest control chemicals previously retained within the plurality of microchannels, causing release of at least a portion of the one or more pest control chemicals from the solid pest barrier, thereby facilitating exposure of the one or more pest control chemicals to the one or more undesirable pests.

According to some embodiments, a method can be carried out that comprises: forming a substantially cord-like material defining therein a plurality of microchannels having an average largest diameter within a predetermined range; and disposing one or more pest control chemicals within the plurality of microchannels defined within the substantially cord-like material to form a solid pest barrier. In some embodiments, the plurality of microchannels are dimensioned and configured to retain the one or more pest control chemicals within the plurality of microchannels using capillary forces. In some embodiments, the one or more pest control chemicals are configured to repel or cause mortality for one or more undesirable pests upon contact or ingestion by the one or more undesirable pests of the one or more pest control chemicals. In some embodiments, the substantially cord-like material is configured to become increasingly friable during a desired pest control period following deployment of the solid pest barrier within an application area. In some embodiments, during the desired pest control duration following deployment of the solid pest barrier within the application area. In some embodiments, as the substantially cord-like material becomes increasingly friable, the plurality of microchannels are dimensioned and configured to release some or all of the one or more pest control chemicals previously retained within the plurality of microchannels, causing release of at least a portion of the one or more pest control chemicals from the solid pest barrier, thereby facilitating exposure of the one or more pest control chemicals to the one or more undesirable pests.

In some embodiments, the porous flexible material is configured to become increasingly friable in response to exposure to one or more environmental elements. In some embodiments, the one or more environmental elements comprise at least one of: sunlight, irrigation water, rain, humidity, wind, heat, cold, or combinations thereof.

According to other embodiments, a method can be carried out that comprises: mixing one or more pest control chemicals into a biodegradable material to form an extrudable mixture; and extruding the extrudable mixture to form a solid pest barrier having a substantially cord-like form factor. In some embodiments, the one or more pest control chemicals are configured to repel or cause mortality for one or more undesirable pests upon contact or ingestion by the one or more undesirable pests of the one or more pest control chemicals. In some embodiments, the biodegradable material is configured to biodegrade during a desired pest control period following deployment of the solid pest barrier within an application area. In some embodiments, during the desired pest control duration following deployment of the solid pest barrier within the application area, as the biodegradable material biodegrades, some or all of the one or more pest control chemicals disposed within the biodegradable material is released from the solid pest barrier, thereby facilitating exposure of the one or more pest control chemicals to the one or more undesirable pests. In some embodiments, the biodegradable material is configured to at biodegrade in response to exposure to one or more environmental elements. In some embodiments, the one or more environmental elements comprise at least one of: sunlight, irrigation water, rain, humidity, wind, heat, cold, or combinations thereof. In some embodiments, the biodegradable material is configured to biodegrade at a rate that is sufficient such that the biodegradable material fully biodegrades at an end of the desired pest control duration following deployment of the solid pest barrier within the application area. In some embodiments, the decomposable material comprises polyglycolic acid, polylactic acid, polycaprolactone (PCL), and poly(lactide-co-glycolide) (PLGA), or combinations thereof.

According to other embodiments, a system can be provided that comprises: a pest control barrier comprising a solid pest barrier material comprising one or more inner volumes defined therein and one or more portions of a pest control chemical disposed within the one or more inner volumes of the solid pest barrier material. In some embodiments, the pest control chemical is configured to repel or cause mortality for an undesired pest upon contact or ingestion of the pest control chemical by the undesirable pest. In some embodiments, the pest control barrier material is dimensioned and configured to releasably retain the one or more portions of the pest control chemical within the one or more inner volumes of the pest control barrier using capillary forces. In some embodiments, the system can further comprise: a pest control chemical reservoir configured to be in fluidic communication with the pest control barrier. In some embodiments, the pest control chemical reservoir is dimensioned and configured to retain a replenishing supply of the pest control chemical within the pest control chemical reservoir.

According to other embodiments, a solid pest barrier can be formed, provided, or deployed. The solid pest barrier can comprise a curable fluid matrix material; and a pest control chemical disposed within the curable fluid matrix material. In some embodiments, a mixture of the pest control chemical and the curable fluid matrix material is extrudable as the solid pest barrier. In some embodiments, the solid pest barrier can have a cord-like form factor. In some embodiments, the curable matrix material is configured to at least partially solidify in response to exposure of the mixture of the pest control chemical and the curable matrix material to a curing trigger, thereby retaining the pest control chemical within the solid pest barrier. In some embodiments, during a treatment period following extrusion of the mixture of the pest control chemical and the curable fluid matrix material as the solid pest barrier, the pest control chemical is configured to repel or cause mortality for one or more undesirable pests upon contact or ingestion by the one or more undesirable pests of the pest control chemical from the solid pest barrier.

In some embodiments, the solid pest barrier can further comprise: an adhesive material disposed to at least a portion of an outside of the solid pest barrier, the adhesive material being configured to join or adhere the solid pest barrier to an outside of a structure. In some embodiments, the curable fluid matrix material is configured to, after extrusion of the mixture of the pest control chemical and the curable fluid matrix material to form the solid pest barrier, become increasingly friable in response to exposure to one or more environmental elements. In some embodiments, the one or more environmental elements comprise at least one of: sunlight, irrigation water, rain, humidity, wind, heat, cold, or combinations thereof. In some embodiments, the curable fluid matrix material is or comprises a biodegradable material. In some embodiments, the biodegradable material is configured to biodegrade during a desired pest control period following deployment of the solid pest barrier within an application area. In some embodiments, during the desired pest control duration following deployment of the solid pest barrier within the application area, as the biodegradable material biodegrades, some or all of the pest control chemical disposed within the biodegradable material is released from the solid pest barrier, thereby facilitating exposure of the pest control chemical to the one or more undesirable pests. In some embodiments, the biodegradable material is configured to at biodegrade in response to exposure to one or more environmental elements. In some embodiments, the one or more environmental elements comprise at least one of: sunlight, irrigation water, rain, humidity, wind, heat, cold, or combinations thereof. In some embodiments, the biodegradable material is configured to biodegrade at a rate that is sufficient such that the biodegradable material fully biodegrades at an end of the desired pest control duration following deployment of the solid pest barrier within the application area. In some embodiments, the curable fluid matrix material is or comprises a decomposable material, the decomposable material comprising at least one of: polyglycolic acid, polylactic acid, polycaprolactone, or poly(lactide-co-glycolide).

According to other embodiments, a solid pest barrier can be provided, formed, or deployed that comprises: a matrix material having a substantially cord-like form factor, the matrix material comprising or defining a plurality of microchannels within the matrix material; and a pest control chemical disposed within the plurality of microchannels within the matrix material. In some embodiments, during a treatment period following disposition of the pest control chemical within the plurality of microchannels within the matrix material, the pest control chemical is configured to repel or cause mortality for one or more undesirable pests upon contact or ingestion by the one or more undesirable pests of the pest control chemical from the solid pest barrier.

In some embodiments, the plurality of microchannels have an average diameter within a predetermined range. In some embodiments, the average diameter of the plurality of microchannels is sufficient to retain the pest control chemical within the plurality of microchannels using capillary forces. In some embodiments, the curable fluid matrix material has a coefficient of moisture expansion within a predetermined coefficient of moisture expansion range. In some embodiments, the coefficient of moisture expansion of the curable fluid matrix material is sufficient such that, when the solid pest barrier absorbs a sufficient amount of moisture, the plurality of microchannels expand such that the plurality of microchannels are no longer dimensioned and configured to retain the pest control chemical within the plurality of microchannels using capillary forces.

According to other embodiments, a solid pest barrier can be provided, formed, or deployed that comprises: a plurality of flexible material elements. In some embodiments, the plurality of flexible material elements can have a strand-like form factor. In some embodiments, the plurality of flexible material elements can comprise a first plurality of pores defined therein. In some embodiments, the plurality of flexible material elements are woven or wound together in a cord-like form factor. In some embodiments, the woven or wound plurality of flexible material elements can define therebetween a second plurality of pores. In some embodiments, the solid pest barrier can further comprise: one or more pest control chemicals disposed within at least a portion of the first plurality of pores within the plurality of flexible material elements. In some embodiments, the one or more pest control chemicals are configured to repel or cause mortality for an undesirable pest upon contact or ingestion by the undesirable pest of the one or more pest control chemicals. In some embodiments, the first plurality of pores are dimensioned and configured to releasably retain the one or more pest control chemicals therewithin using capillary forces. In some embodiments, the second plurality of pores between the plurality of flexible material elements within the solid pest barrier are substantially empty. In some embodiments, in an instance in which an aqueous liquid is absorbed into some or all of the second plurality of pores between the plurality of flexible material elements within the solid pest barrier, the solid pest barrier is configured to release at least a portion of the one or more pest control chemicals releasably retained within the first plurality of pores within respective of the plurality of flexible material elements, thereby facilitating exposure of the one or more pest control chemicals to the one or more undesirable pests.

In some embodiments, the solid pest barrier has a first coefficient of moisture expansion within a first predetermined range. In some embodiments, respective of the flexible material elements have a second coefficient of moisture expansion within a second predetermined range. In some embodiments, the second plurality of pores defined within respective of the plurality of flexible material elements are dimensioned and configured to releasably retain the one or more pest control chemicals within the second plurality of pores using capillary forces. In some embodiments, the solid pest barrier can further comprise: an adhesive material disposed to at least a portion of an outside of the solid pest barrier, the adhesive material being configured to join or adhere the solid pest barrier to an outside of a structure.

From the foregoing, it will be seen that aspects herein are well adapted to attain all the ends and objects hereinabove set forth together with other advantages which are obvious and which are inherent to the structure.

It will be understood that certain features and sub-combinations are of utility and may be employed without reference to other features and sub-combinations. This is contemplated by and is within the scope of the claims.

Since many possible aspects may be made without departing from the scope thereof, it is to be understood that all matter herein set forth or shown in the accompanying drawings is to be interpreted as illustrative and not in a limiting sense.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

1. A solid pest barrier comprising:
a curable fluid matrix material; and
a pest control chemical disposed within the curable fluid matrix material,
wherein a mixture of the pest control chemical and the curable fluid matrix material is extrudable as the solid pest barrier, the solid pest barrier having a cord-like form factor,
wherein the curable matrix material is configured to at least partially solidify in response to exposure of the mixture of the pest control chemical and the curable matrix material to a curing trigger, thereby retaining the pest control chemical within the solid pest barrier, and
wherein, during a treatment period following extrusion of the mixture of the pest control chemical and the curable fluid matrix material as the solid pest barrier, the pest control chemical is configured to repel or cause mortality for an undesirable pest upon contact or ingestion by the undesirable pest of the pest control chemical from the solid pest barrier.

2. The solid pest barrier of claim 1, further comprising:
an adhesive material disposed to at least a portion of an outside of the solid pest barrier, the adhesive material being configured to join or adhere the solid pest barrier to an outside of a structure.

3. The solid pest barrier of claim 1, wherein the curable fluid matrix material is configured to, after extrusion of the mixture of the pest control chemical and the curable fluid matrix material to form the solid pest barrier, become increasingly friable in response to exposure to an environmental element.

4. The solid pest barrier of claim 3, wherein the environmental element comprises at least one of: sunlight, irrigation water, rain, humidity, wind, heat, or cold.

5. The solid pest barrier of claim 1, wherein the curable fluid matrix material is or comprises a biodegradable material.

6. The solid pest barrier of claim 5, wherein the biodegradable material is configured to biodegrade during a desired pest control period following deployment of the solid pest barrier within an application area.

7. The solid pest barrier of claim 6, wherein, during the desired pest control duration following deployment of the solid pest barrier within the application area, as the biodegradable material biodegrades, some or all of the pest control chemical disposed within the biodegradable material is released from the solid pest barrier, thereby facilitating exposure of the pest control chemical to the undesirable pest.

8. The solid pest barrier of claim 6, wherein the biodegradable material is configured to at biodegrade in response to exposure to an environmental element.

9. The solid pest barrier of claim 8, wherein the environmental element comprises at least one of: sunlight, irrigation water, rain, humidity, wind, heat, or cold.

10. The solid pest barrier of claim 6, wherein the biodegradable material is configured to biodegrade at a rate that is sufficient such that the biodegradable material fully biodegrades at an end of the desired pest control duration following deployment of the solid pest barrier within the application area.

11. The solid pest barrier of claim 1, wherein the curable fluid matrix material is or comprises a decomposable material, the decomposable material comprising at least one of: polyglycolic acid, polylactic acid, polycaprolactone, or poly(lactide-co-glycolide).

12. A solid pest barrier comprising:
a matrix material having a substantially cord-like form factor, the matrix material comprising or defining a plurality of microchannels within the matrix material; and
a pest control chemical disposed within the plurality of microchannels within the matrix material,
wherein, during a treatment period following disposition of the pest control chemical within the plurality of microchannels within the matrix material, the pest control chemical is configured to repel or cause mortality for an undesirable pest upon contact or ingestion by the undesirable pest of the pest control chemical released from the solid pest barrier.

13. The solid pest barrier of claim 12, wherein the plurality of microchannels have an average diameter within a predetermined range.

14. The solid pest barrier of claim 13, wherein the average diameter of the plurality of microchannels is sufficient to retain the pest control chemical within the plurality of microchannels using capillary forces.

15. The solid pest barrier of claim 14, wherein the curable fluid matrix material has a coefficient of moisture expansion within a predetermined coefficient of moisture expansion range.

16. The solid pest barrier of claim 15, wherein the coefficient of moisture expansion of the curable fluid matrix material is sufficient such that, when the solid pest barrier absorbs a sufficient amount of moisture, the plurality of microchannels expand such that the plurality of microchannels are no longer dimensioned and configured to retain the pest control chemical within the plurality of microchannels using capillary forces.

17. A solid pest barrier comprising:
a plurality of flexible material elements, the plurality of flexible material elements having a strand-like form factor, the plurality of flexible material elements comprise a first plurality of pores defined therein, the plurality of flexible material elements being woven or wound together in a cord-like form factor, the woven or wound plurality of flexible material elements defining therebetween a second plurality of pores; and
a pest control chemical disposed within at least a portion of the first plurality of pores within the plurality of flexible material elements, the pest control chemical being configured to repel or cause mortality for an undesirable pest upon contact or ingestion by the undesirable pest of the pest control chemical,
wherein the first plurality of pores are dimensioned and configured to releasably retain the pest control chemical therewithin using capillary forces,
wherein the second plurality of pores between the plurality of flexible material elements within the solid pest barrier are substantially empty, and
wherein, in an instance in which an aqueous liquid is absorbed into some or all of the second plurality of pores between the plurality of flexible material elements within the solid pest barrier, the solid pest barrier is configured to release at least a portion of the pest control chemical releasably retained within the first plurality of pores within respective of the plurality of flexible material elements, thereby facilitating exposure of the pest control chemical to the undesirable pest.

18. The solid pest barrier of claim 17, wherein the solid pest barrier has a first coefficient of moisture expansion within a first predetermined range, and wherein respective of the flexible material elements have a second coefficient of moisture expansion within a second predetermined range.

19. The solid pest barrier of claim 17, wherein the second plurality of pores defined within respective of the plurality of flexible material elements are dimensioned and configured to releasably retain the pest control chemical within the second plurality of pores using capillary forces.

20. The solid pest barrier of claim 17, further comprising:
an adhesive material disposed to at least a portion of an outside of the solid pest barrier, the adhesive material being configured to join or adhere the solid pest barrier to an outside of a structure.
